(19) United States
(12) Patent Application Publication
(10) Pub. No.: US 2020/0278997 A1
(43) Pub. Date: Sep. 3, 2020

(54) DESCRIPTIVE MEDIA CONTENT SEARCH FROM CURATED CONTENT

(71) Applicant: Spotify AB, Stockholm (SE)

(72) Inventors: Paul Lamere, Boston, FL (US); Kurt Jacobson, Stoneham, MA (US)

(21) Appl. No.: 16/290,847

(22) Filed: Mar. 1, 2019

(51) Int. Cl. G06F 16/632; G06F 16/638; G06F 16/635; G06F 16/683; G06F 16/68; G06F 16/61; G06F 17/27

(52) U.S. Cl. CPC G06F 16/632; G06F 16/639; G06F 16/635; G06F 17/277; G06F 16/686; G06F 16/61; G06F 16/685

(57) ABSTRACT

A descriptive playlist search solution is provided to allow a user to search for playlists based on descriptions even if such descriptions do not typically appear in playlist metadata. The descriptive playlist search solution uses descriptions of a playlists (e.g., a playlist title or other descriptive text) to label tracks of the playlist. Playlists having the same or similar tracks are then labeled with the same or similar descriptions. The descriptive playlist search solution establishes a descriptive search database using the labeled playlists. The descriptive search database is then searched responsive to the user's descriptive search request is conducted. One or more playlists matching the description are obtained responsive to conducting the search. The playlists are then presented at a media playback device.

### CROSS-REFERENCE TO RELATED APPLICATIONS

This application is related to U.S. patent application Ser. No. 15/988,943, which was filed May 24, 2018, is titled “Descriptive Media Content Search,” and is hereby incorporated by reference herein in its entirety.

### BACKGROUND

Music search algorithms typically conduct searches based on known metadata of the music that is stored in a music library metadata database. The known metadata typically includes information commonly associated with music, such as the name of the music, the name of the artist, a genre, a release date, and the like. This type of music search may be used to help a user to identify a particular track or playlist based on specific metadata known by the user. However, music search of this type does not provide relevant search results if the user query describes something that is not included in the music metadata database, such as certain specific sub-genres or feelings evoked by certain music. In this manner, traditional music search algorithms are limited.

### SUMMARY

In general terms, the present disclosure is directed to descriptive media content search. In one possible configuration and by non-limiting example, the descriptive media content search uses playlist descriptions to provide additional information to describe media content, including curated playlists. Various aspects are described in this disclosure, which include, but are not limited to, the following aspects.

In an example, there is a method for improving algorithmic discoverability of curated playlists. The method includes selecting a candidate playlist from a plurality of uncurated playlists. The candidate playlist has a playlist description and a first plurality of tracks. The playlist description is tokenized into one or more tokenized terms. Each respective track of the first plurality of tracks is tagged with the one or more tokenized terms. A respective curated playlist is selected from a plurality of curated playlists. The curated playlist has a second plurality of tracks. A subset of tracks is selected from the second plurality of tracks. The curated playlist is then made discoverable by a query application via the one or more tokenized terms. Making the curated playlist discoverable includes, for each respective track of the subset of tracks: (1) determining whether the respective track has been tagged with at least one tokenized term and (2) storing, in a descriptive search database, an association between: (A) each of the at least one tokenized term with which the respective track has been tagged and (B) the curated playlist.

Tagging each respective track of the first plurality of tracks can include identifying a respective track-term entry in a track-term database that corresponds to the respective track and ensuring that the respective track-term entry includes an association to the one or more tokenized terms. Determining whether the respective track has been tagged with the at least one tokenized term can include using the track-term database. The descriptive search database can include an inverted index. The second plurality of tracks of the curated playlist has N tracks (where N is an integer) and selecting the subset of tracks from the second plurality of tracks can include selecting M tracks from the curated playlist (where M is an integer less than N). The second plurality of tracks of the curated playlist can have an order. The subset of M tracks can be the first M tracks of the curated playlist in the order. The method can further include obtaining a third playlist and identifying the third playlist as a curated playlist responsive to the third playlist meeting at least one condition. The at least one condition can a condition selected from the group consisting of: the third playlist being authored by an author having escalated privileges; the third playlist being selected by a curator; the third playlist being flagged as a curated playlist; the third playlist having more than a threshold number of listeners; and the third playlist having more than a threshold number of followers. Responsive to identifying the third playlist as a curated playlist, the third playlist can be added to the plurality of curated playlists. Tagging each respective track of the first plurality of tracks with the one or more tokenized terms can include, for each respective term of the one or more tokenized terms, tagging the respective track with the respective term responsive to the respective term passing a privacy filter. The method can further include, prior to tagging each respective track of the first plurality of tracks with the tokenized terms, filtering the tokenized terms to remove terms outside of a lexicon. The method can still further include applying one or more filters to the plurality of uncurated playlists, where the candidate playlist passes the one or more filters. The one or more filters can include a title filter configured to filter playlists based on playlist titles of the playlists, a descriptive text filter configured to filter playlists based on descriptive text of the playlists, or a track filter configured to filter playlists based on the tracks of the playlists. The playlist description can include a playlist title and a descriptive text. In an example, the method further includes: receiving a user query including at least one descriptor, finding an association in the descriptive search database that has the at least one descriptor, determining that the found association is with the curated playlist, and responsive to determining that the found association is with the curated playlist, initiating playback of the curated playlist. In an example, the finding the association in the descriptive search database includes determining whether a relevance score passes a threshold.

In an example, there is a system for improving algorithmic discoverability of curated playlists. The system includes: a playlist database storing a plurality of uncurated playlists and a plurality of curated playlists; a track-term database storing track-term entries, each of the track-term entries associating a track with one or more descriptive terms; a descriptive search database storing descriptive term entries, each of the descriptive term entries associating a descriptive term with at least one curated playlist of the plurality of curated playlists; a descriptive query engine operative to return a playlist result in response to a user query, the playlist result being based on the descriptive search database and one or more descriptors in the user query; one or more processors; and a non-transitory computer-readable medium. The non-transitory computer-readable medium has instructions stored thereon that, when executed by one or more processors, cause the one or more processors to perform a plurality of actions. The actions include selecting candidate playlists from the plurality of uncurated playlists and, for each respective candidate playlist of the candidate playlists: (1) tokenize a playlist description of the respective candidate playlist to form a set of tokenized terms; and (2) for each respective track in the respective candidate playlist: (A) identify a respective track-term entry of the track-term entries that corresponds to the respective track; and (B) ensure that the respective track-term entry includes an association to the set of tokenized terms. The actions further include, for each respective curated playlist of the plurality of curated playlists: (i) selecting a subset of tracks from tracks of the respective curated playlist; and (ii) updating the descriptive search database based on corresponding track-term entries in the track-term database, the corresponding track-term entries corresponding to the subset of tracks.

In further examples of the system, updating the descriptive search database based on corresponding track-term entries includes: for each respective track-term entry of the corresponding track-term entries: for each respective descriptive term of the one or more descriptive terms of the respective track-term entry: selecting a corresponding descriptive term entry of the descriptive term entries that corresponds to the respective descriptive term and ensuring that the respective curated playlist is associated with the corresponding descriptive term entry. Selecting the subset of tracks from tracks of the respective curated playlist can include selecting the first M tracks of the respective curated playlist, where M is an integer less than the total number of tracks in the respective curated playlist. Tokenizing the playlist description of the respective candidate playlist to form the set of tokenized terms can include: applying a lexicon such that the tokenized terms include only those terms allowed by the lexicon.

In another example, there is a method for improving algorithmic discoverability of curated playlists. The method includes: selecting candidate playlists from a plurality of uncurated playlists. The method further includes for each respective candidate playlist of the candidate playlists: (1) tokenize a playlist description of the respective candidate playlist to form a set of tokenized terms; and (2) for each respective track in the respective candidate playlist: (A) identify a respective track-term entry of track-term entries that corresponds to the respective track and (B) ensure that the respective track-term entry includes an association to the set of tokenized terms. The method further includes: for each respective curated playlist of the plurality of curated playlists: (i) selecting a subset of tracks from tracks of the respective curated playlist and (ii) updating the descriptive search database based on corresponding track-term entries in the track-term database, the corresponding track-term entries corresponding to the subset of tracks.

In further examples of the method, updating the descriptive search database based on corresponding track-term entries includes: for each respective track-term entry of the corresponding track-term entries and for each respective descriptive term of the one or more descriptive terms of the respective track-term entry: selecting a corresponding descriptive term entry of the descriptive term entries that corresponds to the respective descriptive term; and ensuring that the respective curated playlist is associated with the corresponding descriptive term entry. Selecting the subset of tracks from tracks of the respective curated playlist can further include selecting the first M tracks of the respective curated playlist, where M is an integer less than the total number of tracks in the respective curated playlist. Tokenizing the playlist description of the respective candidate playlist to form the set of tokenized terms can include applying a lexicon such that the tokenized terms include only those terms allowed by the lexicon.

### BRIEF DESCRIPTION OF THE DRAWINGS

Various embodiments will be described in detail with reference to the drawings, wherein like reference numerals represent like parts and assemblies throughout the several views.

FIG. 1 illustrates an example system for providing media content to a user.

FIG. 2, which is made up of FIGS. 2A and 2B, is a block diagram of an example media playback device of the system shown in FIG. 1.

FIG. 3 is a flowchart of an example method for selecting and providing a playlist responsive to a user query.

FIG. 4 is a flowchart of an example method for processing an utterance of the user query.

FIG. 5 is a flowchart of an example method for performing descriptive search for a playlist based on the user query.

FIG. 6, which is made up of FIGS. 6A, 6B, 6C, and 6D, is a flowchart of an example method for improving algorithmic discoverability of playlists.

FIG. 7 illustrates playlist databases, a candidate playlist selection engine for determining candidate playlists, and a curation engine for curating playlists.

FIG. 8 illustrates producing tokenized terms from a playlist description.

FIG. 9 illustrates an example track-term database having track-term entries that associate one or more tracks with one or more terms.

FIG. 10 illustrates an example descriptive search database.

FIG. 11 is a flowchart of an example method for generating a relevance score.

FIG. 12 is a flowchart of an example method for performing a descriptive search with the descriptive search database.

FIG. 13 illustrates an example method for analyzing the user query to identify one or more search keywords.

FIG. 14 illustrates an example method for selecting playlists based on descriptive search using the descriptive search database.

FIG. 15 illustrates an example method for selecting personalized playlists.

### DETAILED DESCRIPTION

Examples described herein include examples directed to improving the algorithmic discoverability of playlists (e.g., curated playlists) in response to user queries with descriptive terms. For instance, while a media playback system can relatively easily respond to user queries that include descriptive terms with which playlists are typically tagged (e.g., genre, artist, era, or other metadata), that same system can fail to produce relevant results in response to user queries that include other descriptive terms not typically captured by playlist metadata. For instance, a media playback system may easily fulfill a request to “play jazz” by playing a playlist of the jazz genre. But that same media playback system would traditionally fail to be able to fulfill a request to “play a relaxing jazz for tonight”. The system may partially fulfill the request by playing jazz music, but may fail to fulfill the request based on descriptive terms such as “relaxing” or “tonight”. This issue arises in part because such descriptive terms are not traditionally stored as searchable music metadata. Further, while some playlists may have titles like “Relaxing Jazz”, not all playlists may be uniformly or appropriately tagged. So simply returning results of playlists having a title with terms matching descriptive terms in a user query may yield over inclusive results (e.g., a heavy metal playlist containing neither relaxing music nor jazz music may be jokingly titled “Relaxing Jazz” by a user and therefore undesirably show up in the results) and under inclusive results (e.g., a playlist perfectly encompassing relaxing jazz may be called “Chill Jazz” instead and therefore may undesirably be absent from the results). Disclosed embodiments improve the algorithmic discovery of playlists by searches including descriptive terms in a manner relevant to addressing these problems.

In one general example, algorithmic discovery by a media delivery system is improved by using descriptions of playlists (e.g., the title or other descriptive text) to label tracks of a music library of the media delivery system. This labeling creates a large track-term database that matches tracks to terms used to describe the playlists in which those tracks appeared. Then, the process is reversed to label playlists with the descriptive terms of the tracks they contain. The labeling of playlists can be accomplished by creating a descriptive search database that matches descriptive terms to playlists associated with those descriptive terms. Then, when the media delivery system receives a request for “relaxing jazz for tonight”, the descriptive terms “relaxing” and “tonight” can be extracted from the query. The media delivery system can then select a result based on playlists in the descriptive search database associated with all of the descriptive terms. Additional processing can be performed to shape the search results based on the tastes of the requesting user.

The above process allows the media delivery system provide relevant search results even when a query includes general characteristics rather than specific metadata. Such queries can result because, for example, the requesting user do not know specific information about the media content that he or she wants to listen to, but can describe general characteristics of the media content with descriptive terms. Examples of descriptive terms relate to moods (relaxing, happy, sad, somber, etc.), types of activities (such as running, working out, driving, dancing, etc.), or any other descriptors that are not typically found in the metadata of media content but describe some aspect of the media content. For instance, a user may want to listen to music for relaxing after work but the media delivery system may have otherwise struggled to respond to such a request because “music for relaxing after work” is not typically the kind of metadata that a track or playlist is labeled with.

For ease of understanding, reference will be made herein to audio playlists having one or more tracks rather than general media content. However, techniques disclosed herein are applicable to media content in general and a variety of kinds of playlists.

Media content can include audio content and video content. The media content can be stored in any format suitable for electronically storing media content. Non-limiting examples of media content include tracks, albums, audiobooks, music videos, movies, television episodes, podcasts, other types of audio content, other types of video content, and portions or combinations thereof.

At a high level, a playlist is a data structure for identifying a grouping of media content items, such as tracks. Although bearing similarities to albums, television seasons, or other collections of media content items issued by an entity (hereinafter, “issued collections”), as used herein playlists are distinct from such issued collections. In contrast to issued collections, playlists are often created by end-users or curators for public or private consumption without an official release by an entity (e.g., a music publisher). Further, even when a playlist contains a single track, that playlist is distinct from the single track itself at least because the playlist represents a data structure wrapper into which multiple tracks can be added (even if they ultimately are not) or removed. Another distinguishing factor is that playlists are typically mutable and can be empty while issued collections typically are not. Media-playback platforms and applications often distinguish playlists from issued collections at a user-interface level. On an underlying infrastructure level, playlists are typically identified as being distinct from issued collections.

A track is an audio recording. Typically the audio recording is a recording of a piece music (e.g., a song) stored in any suitable format for electronically storing audio. Tracks are often associated with lyrics and metadata. Lyrics refer to vocalized content of the tracks. Most commonly, the vocalized content corresponds to the words of the track, which are typically sung, spoken, or rapped. Metadata is data about data. With respect to media content, metadata is data about the media content itself. For example, with regard to a track, metadata can contain information such as track length, track identifier (e.g., a unique identifier of the track), and track location (e.g., where the track is stored).

### Media Content System

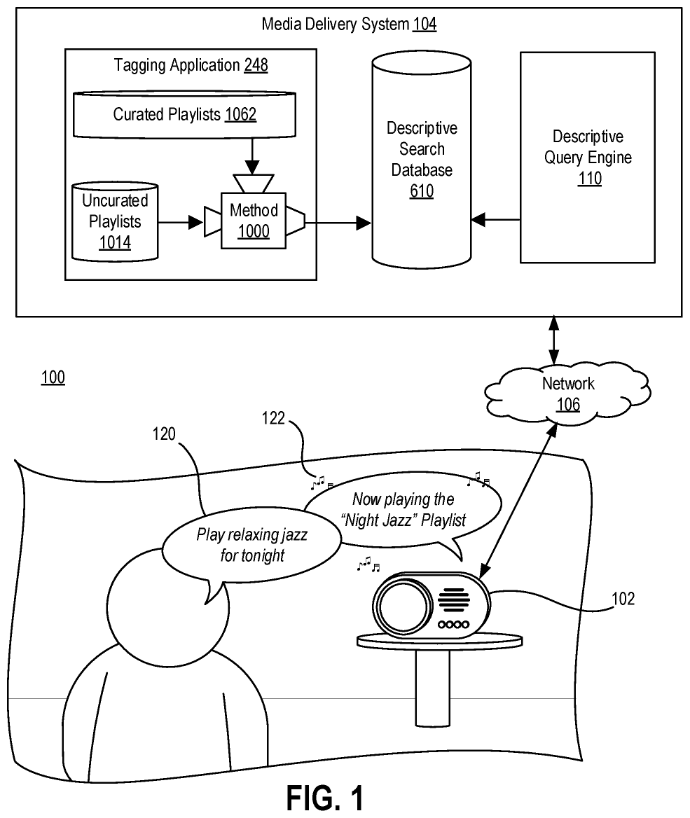

FIG. 1 illustrates an example media content system 100 for providing media content to a user. The media content system 100 includes a media playback device 102, a media delivery system 104, and a network 106 for data communication. The media delivery system 104 includes a descriptive query engine 110. An example user query 120 and a media output 122 are also shown.

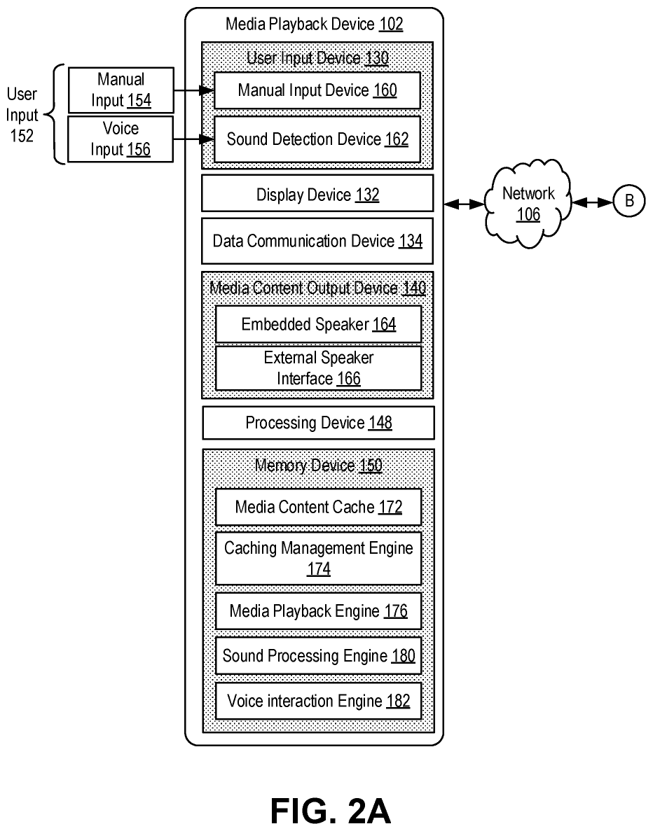

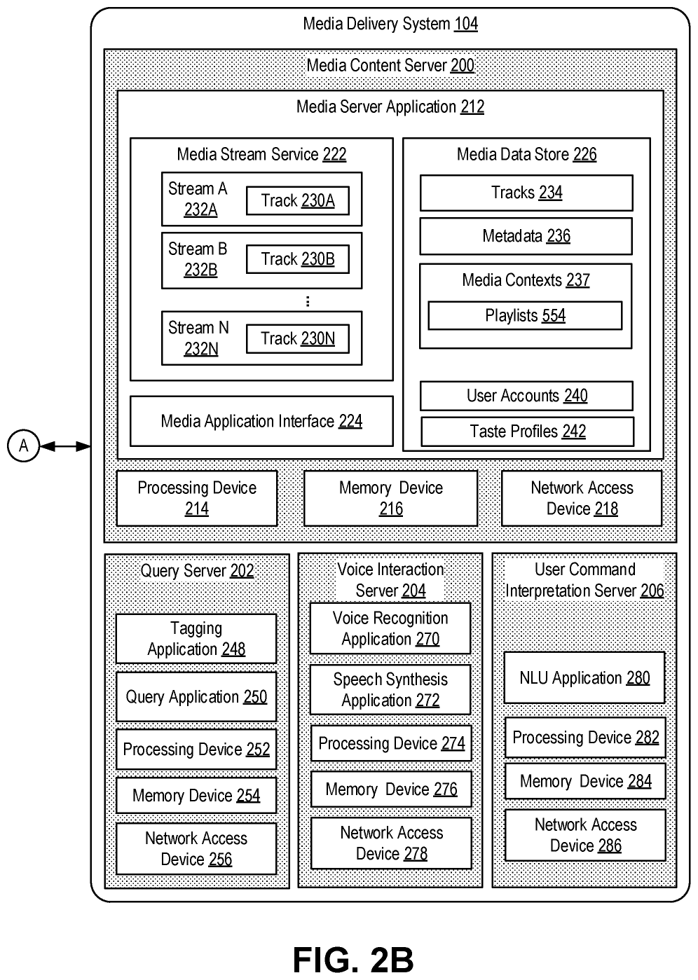

The media playback device 102 operates to provide media content to a user. As described herein, the media playback device 102 operates to receive the user query 120 and provide the media output 122 to the user according to the user query 120. In some embodiments, the media playback device 102 operates to communicate with a system external to the media playback device 102, such as the media delivery system 104. The media playback device 102 can interact with the media delivery system 104 to process the user query 120 and identify media content in response to the user query 120. In some embodiments, the media playback device 102 operates to receive the media content that is identified and provided (e.g., streamed, transmitted, etc.) by the media delivery system 104. In some embodiments, the media playback device 102 operates to play the media content and generate the media output 122 using a media output device (e.g., a speaker) therein. In other embodiments, the media playback device 102 operates to transmit the media content to another device for playback, such as an external speaker or another media playback device (e.g., a vehicle entertainment system or a home entertainment system). An example of the media playback device 102 is illustrated and described in more detail herein, such as with reference to FIG. 2 (particularly, FIG. 2A).

The media delivery system 104 operates to provide media content to one or more media playback devices, including the media playback device 102, via the network 106. An example of the media delivery system 104 is illustrated and described in further detail herein, such as with reference to FIG. 2 (particularly, FIG. 2B).

The media delivery system 104 includes the descriptive query engine 110 that operates to identify media content in response to the user query 120. In many examples herein, the descriptive query engine 110 is operative to return a playlist result in response to a user query 120. The playlist result can be based on the descriptive search database and one or more descriptors 736 in the user query 120.

As described herein, the user query 120 is input received from a user. Examples herein are applicable to handling user queries 120 having descriptive terms. The user query 120 can be also referred to herein as a query, a search request, or the like. In some examples, the user query 120 is text that is typed using the media playback device 102 or another computing device. In other embodiments, the user query 120 can be a voice request received through a sound detection device (e.g., a microphone). As described herein, the voice request can be processed into a text query suitable for media content search.

Where the user query 120 includes one or more descriptive terms (also referred to herein as descriptors), the terms can be used as one or more keywords to identify playlists associated with the keywords. In the illustrated example, the user query 120 is a voice request to “play relaxing jazz for tonight”. In this example, the descriptive terms in the user query 120 can include “relaxing” or its variant (e.g., “relax” or “relaxation”), “tonight” or its variant (e.g., “night” or “nite”), and “jazz” or its variant (e.g., “jazzy”). Alternatively, in this example, the descriptive terms in the user query 120 can include “relaxing jazz” as a single phrase instead of “relaxing” and “jazz” as two separate words. Other examples are also possible.

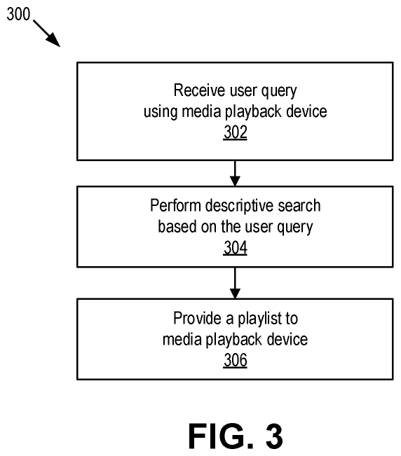

The descriptive query engine 110 operates to select media content based on one or more descriptive terms in the user query 120. For example, the descriptive query engine 110 can identify media content associated with at least one of the descriptive terms of the user query 120, such as “relaxing,” “tonight,” “relaxing jazz,” or “jazz” in the illustrated example. The descriptive query engine 110 can operate by performing a search on the descriptive search database 610 to identify playlists associated with the descriptive terms. An example of the descriptive query engine 110 is illustrated and described in more detail herein, such as with reference to FIG. 3.

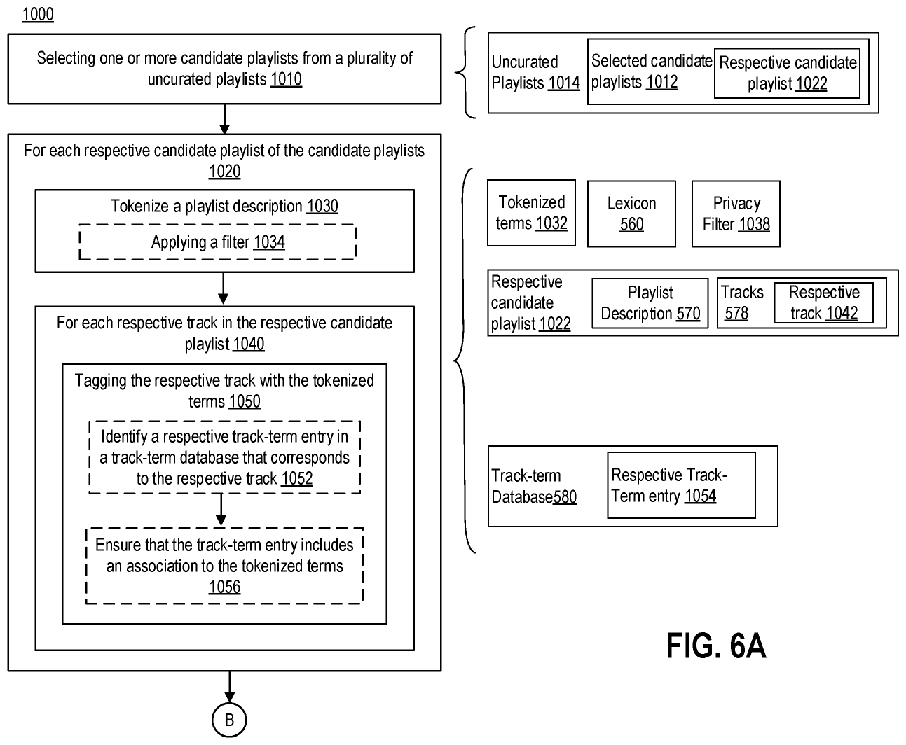

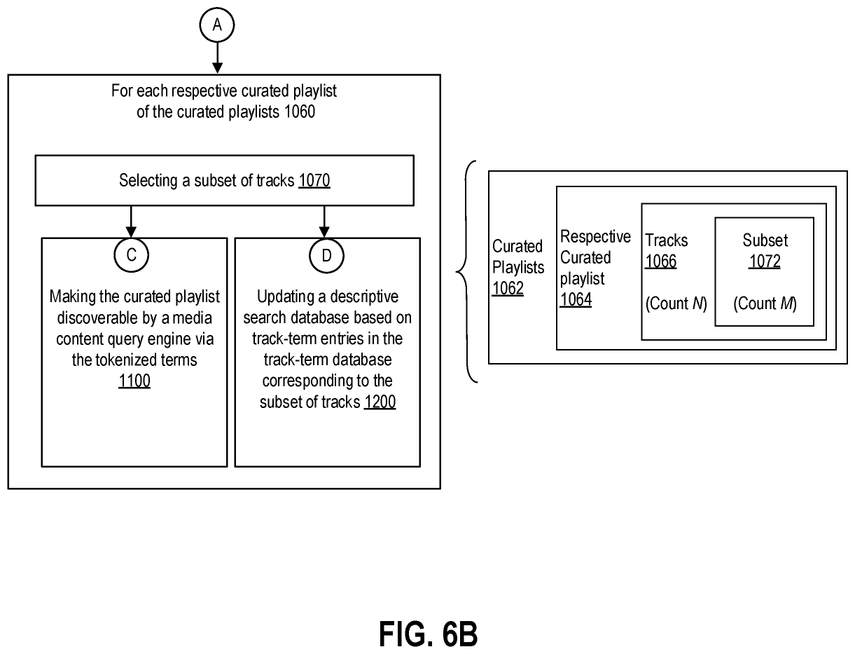

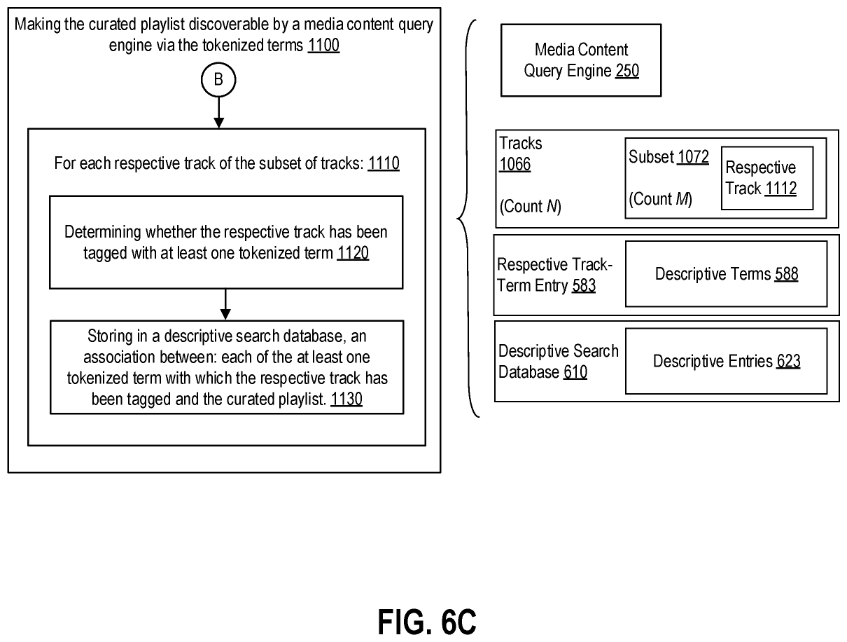

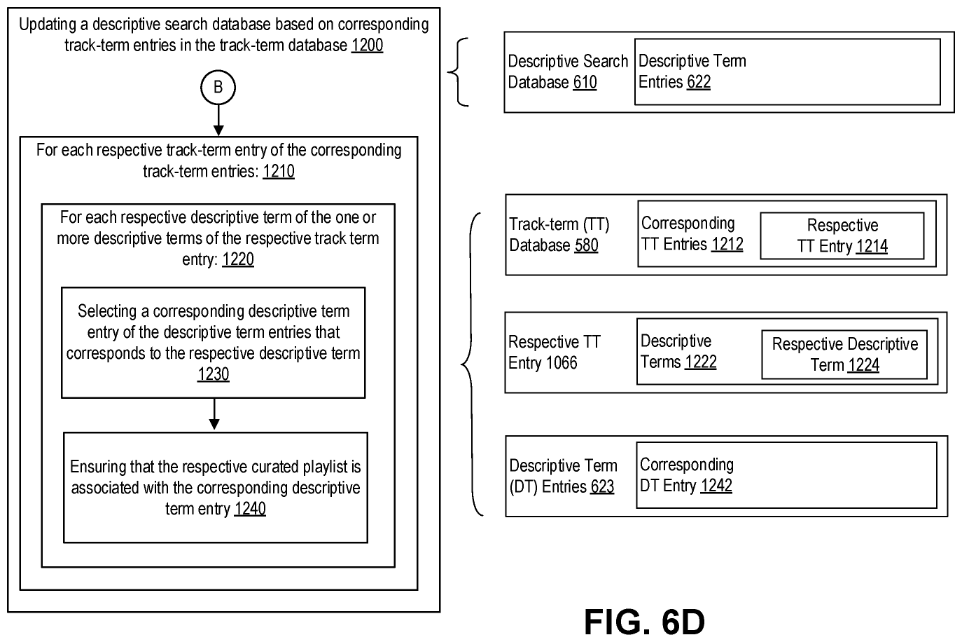

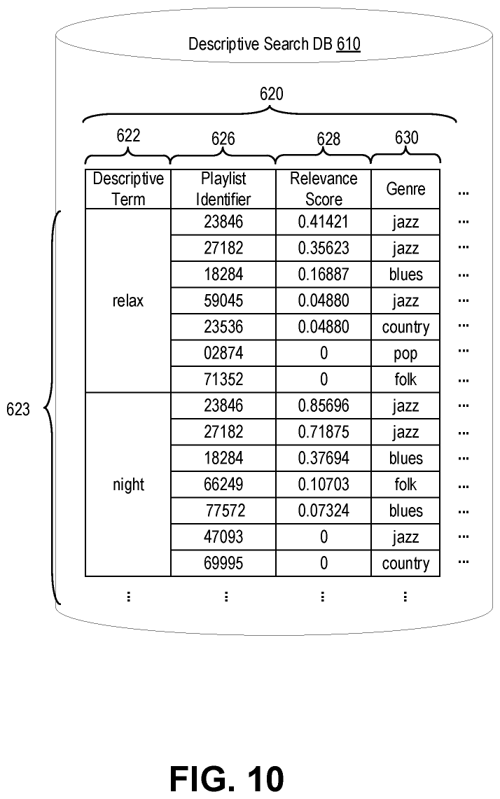

As illustrated, the media delivery system 104 includes a tagging application 248. The tagging application 248 is an algorithm or set of algorithms usable by the media delivery system 104 to create and/or update a descriptive search database 610 to improve the algorithmic discovery of playlists by the descriptive query engine 110. As illustrated, the tagging application 248 uses process 1000 (described in more detail in FIG. 6) to update the descriptive search database 610 (described in more detail in FIG. 10) to increase the algorithmic discoverability of curated playlists 1062 by the descriptive query engine 110 based on data associated with uncurated playlists 1014.

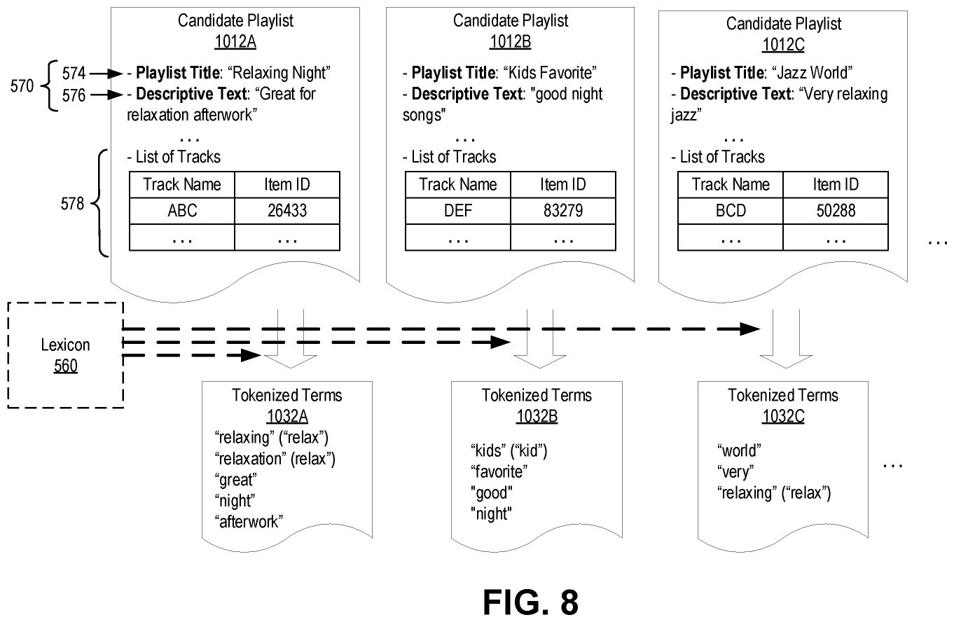

Playlists can be described using a variety of criteria, including whether the playlist is curated or not. As used herein, a curated playlist 1062 is a playlist being flagged or otherwise identified as meeting one or more conditions (e.g., at least one conditions). These conditions typically relate to an aspect of perceived quality or approval of the playlist. For instance, one of the conditions may be that the playlist was created, owned, controlled, or selected by the operator of the media delivery system 104 itself. Additional conditions and aspects of curation are described throughout this application, including with reference to FIG. 8.

At a general level, the tagging application 248 tags tracks with terms based on the descriptions of playlists in which those tracks appear. A data store of such tags is populated based on the uncurated playlists 1014. Then, the tagging application 248 stores the terms in association with the curated playlists 1062 in the descriptive search database 610 based on the tracks that occur in the curated playlists 1062. For example, a curated playlist 1062 having a track that frequently appears in uncurated playlists 1014 described as “groovy” will be tagged by the tagging application 248 as being “groovy”. The descriptive query engine 110 can then use the descriptive search database 610 to look up curated playlists 1062 based on the descriptive terms in the user query 120. In this manner, the algorithmic discoverability of the curated playlists 1062 is improved by storing the curated playlists 1062 in association with the tags.

The network 106 is a data communication network that facilitates data communication between the media playback device 102 and the media delivery system 104. The network 106 typically includes a set of computing devices and communication links between the computing devices. The computing devices in the network 106 use the links to enable communication among the computing devices in the network. The network 106 can include one or more routers, switches, mobile access points, bridges, hubs, intrusion detection devices, storage devices, standalone server devices, blade server devices, sensors, desktop computers, firewall devices, laptop computers, handheld computers, mobile telephones, vehicular computing devices, and other types of computing devices. In various embodiments, the network 106 includes various types of communication links. For example, the network 106 can include wired and/or wireless links, including cellular, BLUETOOTH, WI-FI, ultra-wideband (UWB), 802.11, ZIGBEE, near field communication (NFC), an ultrasonic data transmission, and other types of wireless links. Furthermore, in various embodiments, the network 106 is implemented at various scales. For example, the network 106 can be implemented as one or more vehicle area networks, local area networks (LANs), metropolitan area networks, subnets, wide area networks (WAN) (such as the Internet), or can be implemented at another scale. Further, in some embodiments, the network 106 includes multiple networks, which may be of the same type or of multiple different types.

### Media Playback Device

FIG. 2, which is made up of FIGS. 2A and 2B, is a block diagram of an example media playback device 102 and media delivery system 104 of the system 100 shown in FIG. 1.

FIG. 2A illustrates the media playback device 102 and the network 106, over which the media playback device 102 is communicatively coupled to the media delivery system 104. In the illustrated example, the media playback device 102 includes a user input device 130, a display device 132, a data communication device 134, a media content output device 140, a processing device 148, and a memory device 150.

The media playback device 102 operates to play media content. For example, the media playback device 102 is configured to play media content that is provided (e.g., streamed or transmitted) by a system external to the media playback device 102, such as the media delivery system 104, another system, or a peer device. In other examples, the media playback device 102 operates to play media content stored locally on the media playback device 102. In yet other examples, the media playback device 102 operates to play media content that is stored locally as well as media content provided by other systems.

In some embodiments, the media playback device 102 is a handheld or portable entertainment device, smartphone, tablet, watch, wearable device, or any other type of computing device capable of playing media content. In other embodiments, the media playback device 102 is a laptop computer, desktop computer, television, gaming console, set-top box, network appliance, blue-ray or DVD player, media player, stereo, or radio.

In some embodiments, the media playback device 102 is a system dedicated for streaming personalized media content in a vehicle environment. An example of such a vehicular media playback device is described in U.S. patent application Ser. No. 15/973,198, titled PERSONAL MEDIA STREAMING APPLIANCE SYSTEM, filed May 7, 2018, the disclosure of which is hereby incorporated by reference in its entirety.

The user input device 130 operates to receive a user input 152 from a user for controlling the media playback device 102. As illustrated, the user input 152 can include a manual input 154 and a voice input 156. In some embodiments, the user input device 130 includes a manual input device 160 and a sound detection device 162.

The manual input device 160 operates to receive the manual input 154 for controlling playback of media content via the media playback device 102. In some embodiments, the manual input device 160 includes one or more buttons, keys, touch levers, switches, and/or other mechanical input devices for receiving the manual input 154. For example, the manual input device 160 includes a text entry interface, such as a mechanical keyboard, a virtual keyboard, or a handwriting input device, which is configured to receive a text input, such as a text version of the user query 120. In addition, in some embodiments, the manual input 154 is received for managing various pieces of information transmitted via the media playback device 102 and/or controlling other functions or aspects associated with the media playback device 102.

The sound detection device 162 operates to detect and record sounds from proximate the media playback device 102. For example, the sound detection device 162 can detect sounds including the voice input 156. In some embodiments, the sound detection device 162 includes one or more acoustic sensors configured to detect sounds proximate the media playback device 102. For example, acoustic sensors of the sound detection device 162 include one or more microphones. Various types of microphones can be used for the sound detection device 162 of the media playback device 102.

In some embodiments, the voice input 156 is a user's voice (also referred to herein as an utterance) for controlling playback of media content via the media playback device 102. For example, the voice input 156 includes a voice version of the user query 120 received from the sound detection device 162 of the media playback device 102. In addition, the voice input 156 is a user's voice for managing various data transmitted via the media playback device 102 and/or controlling other functions or aspects associated with the media playback device 102.

In some embodiments, the sounds detected by the sound detection device 162 can be processed by the sound processing engine 180 of the media playback device 102 as described below.

The display device 132 operates to display information to the user. Examples of such information include media content playback information, notifications, and other information. In some embodiments, the display device 132 is configured as a touch sensitive display and includes the manual input device 160 of the user input device 130 for receiving the manual input 154 from a selector (e.g., a finger, stylus etc.) controlled by the user. In some embodiments, therefore, the display device 132 operates as both a display device and a user input device. The display device 132 that is touch sensitive operates to detect inputs based on one or both of touches and near-touches. In some embodiments, the display device 132 displays a graphical user interface for interacting with the media playback device 102. Other embodiments of the display device 132 do not include a touch sensitive display screen. Some embodiments include a display device and one or more separate user interface devices. Further, some embodiments do not include a display device.

The data communication device 134 operates to enable the media playback device 102 to communicate with one or more computing devices over one or more networks, such as the network 106. For example, the data communication device 134 is configured to communicate with the media delivery system 104 and receive media content from the media delivery system 104 at least partially via the network 106. The data communication device 134 can be a network interface of various types which connects the media playback device 102 to the network 106. Examples of the data communication device 134 include wired network interfaces and wireless network interfaces. Wireless network interfaces can include or be implemented with technologies including infrared technology, BLUETOOTH wireless technology, 802.11a/b/g/n/ac technology, cellular technology, or radio frequency interface technology, among others. Examples of cellular network technologies include LTE, WIMAX, UMTS, CDMA2000, GSM, cellular digital packet data (CDPD), and MOBITEX.

The media content output device 140 operates to output media content. In some embodiments, the media content output device 140 generates the media output 122 for the user. In some embodiments, the media content output device 140 includes one or more embedded speakers 164 which are incorporated in the media playback device 102.

Alternatively or in addition, some embodiments of the media playback device 102 include an external speaker interface 166 as an alternative output of media content. The external speaker interface 166 is configured to connect the media playback device 102 to another system having one or more speakers, such as headphones, a portal speaker, and a vehicle entertainment system, so that the media output 122 is generated via the speakers of the other system external to the media playback device 102. Examples of the external speaker interface 166 include an audio output jack, a USB port, a Bluetooth transmitter, a display panel, and a video output jack. Other embodiments are possible as well. For example, the external speaker interface 166 is configured to transmit a signal that can be used to reproduce an audio signal by a connected or paired device such as headphones or a speaker.

The processing device 148, in some embodiments, comprises one or more central processing units (CPUs). In other embodiments, the processing device 148 additionally or alternatively includes one or more digital signal processors, field-programmable gate arrays, or other electronic circuits.

The memory device 150 typically includes at least some form of computer-readable media. The memory device 150 can include at least one data storage device. Computer readable media includes any available media that can be accessed by the media playback device 102. By way of example, computer-readable media includes computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory and other memory technology, compact disc read only memory, BLU-RAY discs, digital versatile discs or other optical storage, magnetic storage devices, or any other medium that can be used to store the desired information and that can be accessed by the media playback device 102. In some embodiments, computer readable storage media is non-transitory computer readable storage media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The memory device 150 operates to store data and instructions. In some embodiments, the memory device 150 stores instructions for a media content cache 172, a caching management engine 174, a media playback engine 176, a sound processing engine 180, and a voice interaction engine 182.

Some embodiments of the memory device 150 include the media content cache 172. The media content cache 172 stores tracks, such as tracks that have been received from the media delivery system 104. The tracks stored in the media content cache 172 may be stored in an encrypted or unencrypted format. In some embodiments, the media content cache 172 also stores track metadata. The media content cache 172 can further store playback information about the tracks and/or other information associated with the tracks.

The caching management engine 174 is configured to receive and cache media content in the media content cache 172 and manage the media content stored in the media content cache 172. In some embodiments, when media content is streamed from the media delivery system 104, the caching management engine 174 operates to cache at least a portion of the media content into the media content cache 172. In other embodiments, the caching management engine 174 operates to cache at least a portion of media content into the media content cache 172 while online so that the cached media content is retrieved for playback while the media playback device 102 is offline.

The media playback engine 176 operates to play media content to the user. As described herein, the media playback engine 176 is configured to communicate with the media delivery system 104 to receive one or more tracks (e.g., through the media stream 232). In other embodiments, the media playback engine 176 is configured to play media content that is locally stored in the media playback device 102.

In some embodiments, the media playback engine 176 operates to retrieve one or more tracks that are either locally stored in the media playback device 102 or remotely stored in the media delivery system 104. In some embodiments, the media playback engine 176 is configured to send a request to the media delivery system 104 for tracks and receive information about such tracks for playback.

The sound processing engine 180 is configured to receive sound signals obtained from the sound detection device 162 and process the sound signals to identify different sources of the sounds received via the sound detection device 162. In some embodiments, the sound processing engine 180 operates to filter the voice input 156 (e.g., a voice request of the user query 120) from noises included in the detected sounds. Various noise cancellation technologies, such as active noise control or cancelling technologies or passive noise control or cancelling technologies, can be used to filter the voice input from ambient noise. In examples, the sound processing engine 180 filters out omni-directional noise and preserves directional noise (e.g., an audio input difference between two microphones) in audio input. In examples, the sound processing engine 180 removes frequencies above or below human speaking voice frequencies. In examples, the sound processing engine 180 subtracts audio output of the device from the audio input to filter out the audio content being provided by the device. (e.g., to reduce the need of the user to shout over playing music). In examples, the sound processing engine 180 performs echo cancellation. By using one or more of these techniques, the sound processing engine 180 provides sound processing customized for use in a vehicle environment.

In other embodiments, the sound processing engine 180 operates to process the received sound signals to identify the sources of particular sounds of the sound signals, such as people's conversation in the vehicle, the vehicle engine sound, or other ambient sounds associated with the vehicle.

In some embodiments, a recording of sounds captured using the sound detection device 162 can be analyzed using speech recognition technology to identify words spoken by the user. The words may be recognized as commands from the user that alter the playback of media content and/or other functions or aspects of the media playback device 102. In some embodiments, the words and/or the recordings may also be analyzed using natural language processing and/or intent recognition technology to determine appropriate actions to take based on the spoken words. Additionally or alternatively, the sound processing engine 180 may determine various sound properties about the sounds proximate the media playback device 102 such as volume, dominant frequency or frequencies, etc. These sound properties may be used to make inferences about the environment proximate to the media playback device 102.

The voice interaction engine 182 operates to cooperate with the media delivery system 104 (e.g., a voice interaction server 204 thereof) to identify a command (e.g., a user intent) that is conveyed by the voice input 156. In some embodiments, the voice interaction engine 182 transmits the voice input 156 that is detected by the sound processing engine 180 to the media delivery system 104 so that the media delivery system 104 operates to determine a command intended by the voice input 156. In other embodiments, at least some of the determination process of the command can be performed locally by the voice interaction engine 182.

In addition, some embodiments of the voice interaction engine 182 can operate to cooperate with the media delivery system 104 (e.g., the voice interaction server 204 thereof) to provide a voice assistant that performs various voice-based interactions with the user, such as voice feedbacks, voice notifications, voice recommendations, and other voice-related interactions and services.

### Media Delivery System

Turning to FIG. 2B, the media delivery system 104 includes a media content server 200, a query server 202, a voice interaction server 204, and a user command interpretation server 206.

The media delivery system 104 comprises one or more physical or virtual computing environments and provides media content to the media playback device 102 and, in some embodiments, other media playback devices as well. In addition, the media delivery system 104 interacts with the media playback device 102 to provide the media playback device 102 with various functionalities.

In at least some embodiments, the media content server 200, the query server 202, the voice interaction server 204, and the user command interpretation server 206 are provided by separate computing devices. In other embodiments, the media content server 200, the query server 202, the voice interaction server 204, and the user command interpretation server 206 are provided by the same computing device(s). Further, in some embodiments, at least one of the media content server 200, the query server 202, the voice interaction server 204, and the user command interpretation server 206 is provided by multiple computing devices. For example, the media content server 200, the query server 202, the voice interaction server 204, and the user command interpretation server 206 may be provided by multiple redundant servers located in multiple geographic locations.

Although FIG. 2B shows a single media content server 200, a single query server 202, a single voice interaction server 204, and a single user command interpretation server 206, some embodiments include multiple media content servers, query servers, voice interaction servers, and user command interpretation servers. In these embodiments, each of the multiple media content servers, query servers, voice interaction servers, and user command interpretation servers may be identical or similar to the media content server 200, the query server 202, the voice interaction server 204, and the user command interpretation server 206, respectively, as described herein, and may provide similar functionality with, for example, greater capacity and redundancy and/or services from multiple geographic locations. Alternatively, in these embodiments, some of the multiple media content servers, the query servers, the voice interaction servers, and/or the user command interpretation servers may perform specialized functions to provide specialized services. Various combinations thereof are possible as well.

The media content server 200 transmits stream media to media playback devices such as the media playback device 102. In some embodiments, the media content server 200 includes a media server application 212, a processing device 214, a memory device 216, and a network access device 218. The processing device 214 and the memory device 216 may be similar to the processing device 148 and the memory device 150, respectively, which have each been previously described. Therefore, the description of the processing device 214 and the memory device 216 are omitted for brevity purposes.

The network access device 218 operates to communicate with other computing devices over one or more networks, such as the network 106. Examples of the network access device include one or more wired network interfaces and wireless network interfaces. Examples of such wireless network interfaces of the network access device 218 include wireless wide area network (WWAN) interfaces (including cellular networks) and wireless local area network (WLANs) interfaces. In other examples, other types of wireless interfaces can be used for the network access device 218.

In some embodiments, the media server application 212 is configured to stream media content, such as music or other audio, video, or other suitable forms of media content. The media server application 212 includes a media stream service 222, a media application interface 224, and a media data store 226. The media stream service 222 operates to buffer media content, such as tracks 230A, 230B, and 230N (collectively 230), for streaming to one or more media streams 232A, 232B, and 232N (collectively 232).

The media application interface 224 can receive requests or other communication from media playback devices or other systems, such as the media playback device 102, to retrieve tracks from the media content server 200. For example, in FIG. 2, the media application interface 224 receives communication from the media playback device 102 to receive media content from the media content server 200.

In some embodiments, the media data store 226 stores: tracks 234, metadata 236, media contexts 237, user accounts 240, and taste profiles 242. The media data store 226 may comprise one or more databases and file systems to store the data. Other embodiments are possible as well. The tracks 234 (including the tracks 230) may be stored in any format for storing media content.

The metadata 236 provides various information associated with the tracks 234 and the media contexts 237. In some embodiments, the metadata 236 includes one or more of title, artist name, album name, length, genre, mood, era, etc.

The metadata 236 operates to provide various pieces of information associated with the tracks 234 and/or the media contexts 237. In some embodiments, the metadata 236 includes one or more of title, artist name, album name, length, genre, mood, era, etc.

In some embodiments, the metadata 236 includes acoustic metadata, cultural metadata, and explicit metadata. The acoustic metadata may be derived from analysis of the track and refers to a numerical or mathematical representation of the sound of a track. Acoustic metadata may include temporal information such as tempo, rhythm, beats, downbeats, tatums, patterns, sections, or other structures. Acoustic metadata may also include spectral information such as melody, pitch, harmony, timbre, chroma, loudness, vocalness, or other possible features. Acoustic metadata may take the form of one or more vectors, matrices, lists, tables, and other data structures. Acoustic metadata may be derived from analysis of the music signal. One form of acoustic metadata, commonly termed an acoustic fingerprint, may uniquely identify a specific track. Other forms of acoustic metadata may be formed by compressing the content of a track while retaining some or all of its musical characteristics.

The cultural metadata refers to text-based information describing listeners' reactions to a track or song, such as styles, genres, moods, themes, similar artists and/or songs, rankings, etc. Cultural metadata may be derived from expert opinion such as music reviews or classification of music into genres. Cultural metadata may be derived from listeners through websites, chatrooms, blogs, surveys, and the like. Cultural metadata may include sales data, shared collections, lists of favorite songs, and any text information that may be used to describe, rank, or interpret music. Cultural metadata may also be generated by a community of listeners and automatically retrieved from Internet sites, chat rooms, blogs, and the like. Cultural metadata may take the form of one or more vectors, matrices, lists, tables, and other data structures. A form of cultural metadata particularly useful for comparing music is a description vector. A description vector is a multi-dimensional vector associated with a track, album, or artist. Each term of the description vector indicates the probability that a corresponding word or phrase would be used to describe the associated track, album or artist.

The explicit metadata refers to factual or explicit information relating to music. Explicit metadata may include album and song titles, artist and composer names, other credits, album cover art, publisher name and product number, and other information. Explicit metadata is generally not derived from the music itself or from the reactions or opinions of listeners.

At least some of the metadata 236, such as explicit metadata (names, credits, product numbers, etc.) and cultural metadata (styles, genres, moods, themes, similar artists and/or songs, rankings, etc.), for a large library of songs or tracks can be evaluated and provided by one or more third party service providers. Acoustic and cultural metadata may take the form of parameters, lists, matrices, vectors, and other data structures. Acoustic and cultural metadata may be stored as XML files, for example, or any other appropriate file type. Explicit metadata may include numerical, text, pictorial, and other information. Explicit metadata may also be stored in an XML, or other file. All or portions of the metadata may be stored in separate files associated with specific tracks. All or portions of the metadata, such as acoustic fingerprints and/or description vectors, may be stored in a searchable data structure, such as a k-D tree or other database format.

Each of the media contexts 237 is used to identify one or more tracks 234. In some embodiments, the media contexts 237 are configured to group one or more tracks 234 and provide a particular context to the group of tracks 234. Some examples of the media contexts 237 include albums, artists, playlists, and individual tracks. By way of example, where a media context 237 is an album, the media context 237 can represent that the tracks 234 identified by the media context 237 are associated with that album.

As described above, the media contexts 237 can include playlists 554. The playlists 554 are data structures for identifying a grouping of media content items, such as one or more tracks 234. In some embodiments, the playlists 554 identify a group of the tracks 234 in a particular order. In other embodiments, the playlists 554 merely identify a group of the tracks 234 without specifying a particular order. Some, but not necessarily all, of the tracks 234 included in a particular one of the playlists 554 are associated with a common characteristic such as a common genre, mood, or era.

In some embodiments, a user can listen to tracks in a playlist 554 by selecting the playlist 554 via a media playback device, such as the media playback device 102. The media playback device then operates to communicate with the media delivery system 104 so that the media delivery system 104 retrieves the tracks identified by the playlist 554 and transmits data for the tracks to the media playback device for playback.

In some embodiments, the playlist 554 includes one or more playlist descriptions, such as a playlist description 570 as illustrated in FIG. 8. The playlist descriptions include information associated with the playlist 554. The playlist descriptions can include a playlist title, such as a playlist title 574 as illustrated in FIG. 8. The playlist title is a title of the playlist. In some embodiments, the playlist title can be provided by a user using the media playback device 102. In other embodiments, the playlist title can be provided by a media content provider (or a media-streaming service provider). In yet other embodiments, the playlist title can be automatically generated.

Other examples of playlist descriptions include a descriptive text, such as a descriptive text 576 as illustrated in FIG. 8. The descriptive text can be provided by the user and/or the media content provider, which is to represent the corresponding playlist 554. For instance, the media delivery system 104 can obtain the descriptive text over a user interface usable by the user to create a playlist. In addition or instead, the descriptive text of the playlist description can be obtained from one or more other sources. Such other sources can include expert opinion (e.g., music reviews or classification of music into genres), user opinion (e.g., reviews through websites, chatrooms, blogs, surveys, and the like), statistics (e.g., sales data), shared collections, lists of favorite playlists, and any text information that may be used to describe, rank, or interpret the playlist or music associated with the playlist. In some embodiments, the playlist descriptions can also be generated by a community of listeners and automatically retrieved from Internet sites, chat rooms, blogs, and the like.

In some embodiments, the playlist descriptions can take the form of one or more vectors, matrices, lists, tables, and other data structures. A form of cultural metadata particularly useful for comparing music is a description vector. A description vector is a multi-dimensional vector associated with a track, album, or artist. Each term of the description vector indicates the probability that a corresponding word or phrase would be used to describe the associated track, album or artist. Each term of the description vector indicates the probability that a corresponding word or phrase would be used to describe the associated track, album or artist.

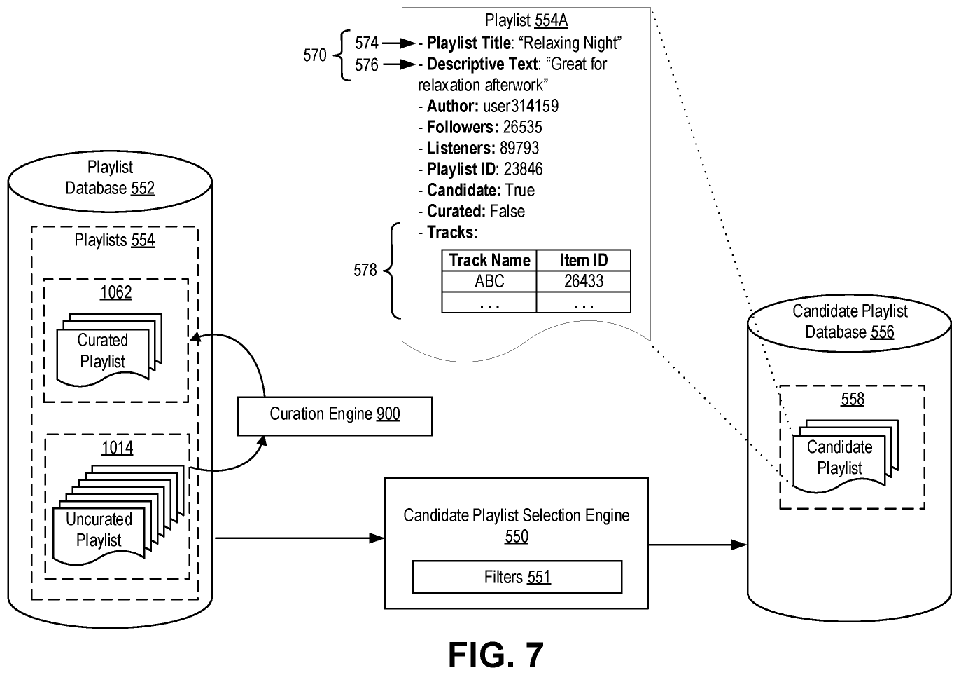

In some embodiments, the playlist 554 includes a list of track identifiers, such as track identifiers 578 as illustrated in FIG. 7. The list of track identifiers includes one or more track identifiers that refer to respective tracks 234. Each track is identified by a track identifier and includes various pieces of information, such as a track title, artist identification (e.g., individual artist name or group name, or multiple artist names or group names), and track data. In some embodiments, the track title and the artist identifier are part of the metadata 236, which can further include other attributes of the track, such as album name, length, genre, mood, era, etc. as described herein.

At least some of the playlists 554 may include user-created playlists. For example, a user of a media streaming service provided using the media delivery system 104 can create a playlist 554 and edit the playlist 554 by adding, removing, and rearranging tracks in the playlist 554. A playlist 554 can be created and/or edited by a group of users together to make it a collaborative playlist. In some embodiments, user-created playlists can be available to a particular user only, a group of users, or to the public based on a user-definable privacy setting.

In some embodiments, when a playlist is created by a user or a group of users, the media delivery system 104 operates to generate a list of tracks recommended for the particular user or the particular group of users. In some embodiments, such recommended tracks can be selected based at least on the taste profiles 242 as described herein. Other information or factors can be used to determine the recommended tracks. Examples of determining recommended tracks are described in U.S. patent application Ser. No. 15/858,377, titled MEDIA CONTENT ITEM RECOMMENDATION SYSTEM, filed Dec. 29, 2017, the disclosure of which is hereby incorporated by reference in its entirety.

In addition or alternatively, at least some of the playlists 554 are created by a media streaming service provider. For example, such provider-created playlists can be automatically created by the media delivery system 104. In some embodiments, a provider-created playlist can be customized to a particular user or a particular group of users. By way of example, a playlist for a particular user can be automatically created by the media delivery system 104 based on the user's listening history (e.g., the user's taste profile) and/or listening history of other users with similar tastes. In other embodiments, a provider-created playlist can be configured to be available for the public in general. Provider-created playlists can also be sharable with other users.

The user accounts 240 are used to identify users of a media streaming service provided by the media delivery system 104. In some embodiments, a user account 240 allows a user to authenticate to the media delivery system 104 and enable the user to access resources (e.g., tracks, playlists, etc.) provided by the media delivery system 104. In some embodiments, the user can use different devices to log into the user account and access data associated with the user account in the media delivery system 104. User authentication information, such as a username, an email account information, a password, and other credentials, can be used for the user to log into his or her user account. It is noted that, where user data is to be protected, the user data is handled according to robust privacy and data protection policies and technologies. For instance, whenever personally identifiable information and any other information associated with users is collected and stored, such information is managed and secured using security measures appropriate for the sensitivity of the data. Further, users can be provided with appropriate notice and control over how any such information is collected, shared, and used.

The taste profiles 242 contain records indicating media content tastes of users. A taste profile can be associated with a user and used to maintain an in-depth understanding of the music activity and preference of that user, enabling personalized recommendations, taste profiling and a wide range of social music applications. Libraries and wrappers can be accessed to create taste profiles from a media library of the user, social website activity and other specialized databases to obtain music preferences.

In some embodiments, each taste profile 242 is a representation of musical activities, such as user preferences and historical information about the users' consumption of media content, and can include a wide range of information such as artist plays, song plays, skips, dates of listen by the user, songs per day, playlists, play counts, start/stop/skip data for portions of a song or album, contents of collections, user rankings, preferences, or other mentions received via a client device, or other media plays, such as websites visited, book titles, movies watched, playing activity during a movie or other presentations, ratings, or terms corresponding to the media, such as “comedy,” etc.

In addition, the taste profiles 242 can include other information. For example, the taste profiles 242 can include libraries and/or playlists of tracks associated with the user. The taste profiles 242 can also include information about the user's relationships with other users (e.g., associations between users that are stored by the media delivery system 104 or on a separate social media site).

The taste profiles 242 can be used for a number of purposes. One use of taste profiles is for creating personalized playlists (e.g., personal playlisting). An API call associated with personal playlisting can be used to return a playlist customized to a particular user. For example, the tracks listed in the created playlist are constrained to the tracks in a taste profile associated with the particular user. Another example use case is for event recommendation. A taste profile can be created, for example, for a festival that contains all the artists in the festival. Music recommendations can be constrained to artists in the taste profile. Yet another use case is for personalized recommendation, where the contents of a taste profile are used to represent an individual's taste. This API call uses a taste profile as a seed for obtaining recommendations or playlists of similar artists. Yet another example of taste profile use case is referred to as bulk resolution. A bulk resolution API call is used to resolve taste profile items to pre-stored identifiers associated with a service, such as a service that provides metadata about items associated with the taste profile (e.g., song tempo for a large catalog of items). Yet another example use case for taste profiles is referred to as user-to-user recommendation. This API call is used to discover users with similar tastes by comparing the similarity of taste profile item(s) associated with users.

A taste profile 242 can represent a single user or multiple users. Conversely, a single user or entity can have multiple taste profiles 242. For example, one taste profile can be generated in connection with a user's media content play activity, whereas another separate taste profile can be generated for the same user based on the user's selection of tracks and/or artists for a playlist.

The query server 202 operates to perform media content search in response to a media content search request, such as the user query 120. In some embodiments, the query server 202 includes, the tagging application 248, a query application 250, a processing device 252, a memory device 254, and a network access device 256. The processing device 252, the memory device 254, and the network access device 256 may be similar to the processing device 214, the memory device 216, and the network access device 218, respectively, which have each been previously described.

In some embodiments, the query application 250 operates to interact with the media playback device 102 and provide selection of one or more tracks based on the user query 120. As described herein, the query application 250 can include the descriptive query engine 110. The query application 250 can interact with other servers, such as the media content server 200, the voice interaction server 204, and the user command interpretation server 206, to perform media content search.

The voice interaction server 204 operates to provide various voice-related functionalities to the media playback device 102. In some embodiments, the voice interaction server 204 includes a voice recognition application 270, a speech synthesis application 272, a processing device 274, a memory device 276, and a network access device 278. The processing device 274, the memory device 276, and the network access device 278 may be similar to the processing device 214, the memory device 216, and the network access device 218, respectively, which have each been previously described.

In some embodiments, the voice recognition application 270 and the speech synthesis application 272, either individually or in combination, operate to interact with the media playback device 102 and enable the media playback device 102 to perform various voice-related functions, such as voice media content search, voice feedback, voice notifications, etc.

In some embodiments, the voice recognition application 270 is configured to perform speech-to-text (STT) conversion, such as receiving a recording of voice command (e.g., an utterance) and converting the utterance to a text format.

In some embodiments, the speech synthesis application 272 is configured to perform text-to-speech (TTS) conversion, so that a language text is converted into speech. Then, the voice interaction server 204 can transmit an audio data or file for the speech to the media playback device 102 so that the media playback device 102 generates a voice assistance to the user using the transmitted audio data or file.

The user command interpretation server 206 operates to analyze a text version of a user command (e.g., a text version of the utterance) to determine appropriate actions to take according to the user command.

In some embodiments, the user command interpretation server 206 includes natural language understanding (NLU) capabilities, such as via an NLU application 280, a processing device 282, a memory device 284, and a network access device 286. The processing device 282, the memory device 284, and the network access device 286 may be similar to the processing device 214, the memory device 216, and the network access device 218, respectively, which have each been previously described.

In some embodiments, the NLU application 280 operates to analyze the text format of the utterance to determine functions to perform based on the utterance. The NLU application 280 can use a natural language understanding algorithm that involves modeling human reading comprehension, such as parsing and translating an input according to natural language principles.

### Selecting and Providing a Playlist Responsive to a User Query

FIG. 3 is a flowchart of an example method 300 for selecting and providing a playlist responsive to a user query 120. The method 300 is at least partially performed by the media delivery system 104 (e.g., the descriptive query engine 110 thereof) that interacts with the media playback device 102. In other embodiments, the method 300 can be at least partially performed by the media playback device 102 that interacts with the media delivery system 104. In yet other embodiments, the method 300 can be at least partially performed by the media playback device 102 and the media delivery system 104 operating cooperatively.

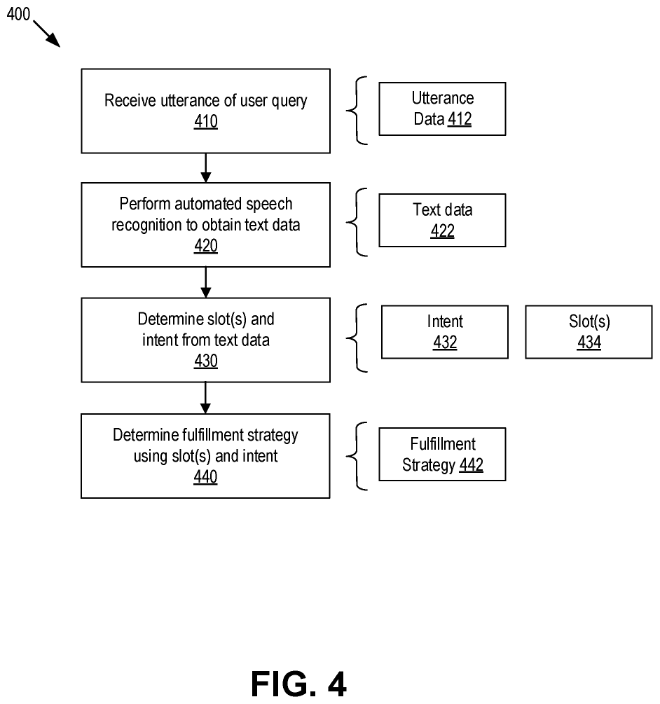

At operation 302, the media delivery system 104 operates to receive the user query 120. In some embodiments, the user query 120 can be received using the media playback device 102. The user query 120 is a request for the media delivery system 104 to take an action. The user query 120 typically originates at the media playback device 102. The user query 120 can originate as text input entered at the media playback device 102 (e.g., typed into a search field), an utterance received and recorded using the media playback device 102, or from another origin. Regarding text input, the user can type in the text (e.g., “play relaxing jazz for tonight”) via the manual input device 160 of the media playback device 102. In some embodiments, the text of the user query 120 can be analyzed to identify descriptive terms (e.g., descriptors) that are to be used for media content search as described herein.

Where the user query 120 is an utterance (e.g., an audio form of “play relaxing jazz for tonight”), the utterance can be received at the sound detection device 162 of the media playback device 102. The utterance of the user query 120 received via the media playback device 102 can be processed into a text version and further analyzed to identify descriptive terms (e.g., descriptors) that can be used for media content search as described herein. An example method for processing the utterance of the user query 120 is illustrated and described in more detail herein, for example with reference to FIG. 4.

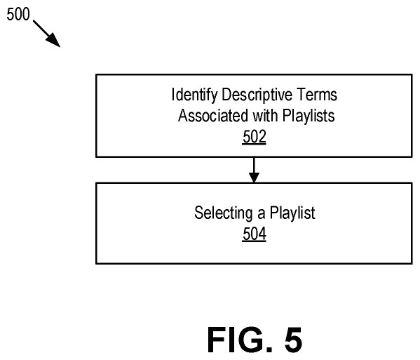

At operation 304, the media delivery system 104 operates to perform descriptive search based on the user query 120. The descriptive search can identify playlists that are relevant to the user query 120 (e.g., relevant to descriptive terms of the user query 120). Other criteria can be used to determine playlists responsive to the user query 120. An example method for performing such descriptive search is illustrated and described in more detail herein, for example with reference to FIG. 5.

At operation 306, the media delivery system 104 operates to provide identified one or more playlists to the media playback device 102. In some embodiments, the media delivery system 104 operates to transmit a media stream 232 for the identified one or more playlists to the media playback device 102 via the network 106.

### Processing an Utterance

FIG. 4 is a flowchart of an example method 400 for processing an utterance, such as an utterance of the user query 120. The method 400 can also be performed to determine a descriptive media content search service as a fulfillment strategy based on the utterance of the user query 120. In some embodiments, the method 400 can be used to at least partially perform the operation 302 of the method 300 in FIG. 3.

In some embodiments, the method 400 can be performed by the media delivery system 104. For example, the method 400 can be used by the natural language understanding (NLU) system (e.g., the NLU application 280) for performing a fulfillment strategy based on a received utterance. As described herein, the media delivery system 104 can include the user command interpretation server 206 that operates the NLU application 280, and the media playback device 102 can receive an utterance of the user query 120 and provide the utterance to the media delivery system 104 for processing at the user command interpretation server 206. This is for example purposes only, and other configurations are possible. For instance, the NLU application 280 is locally saved and performed in the media playback device 102.

The method 400 can begin at operation 410 in which the media delivery system 104 receives the utterance of the user query 120. The utterance of the user query 120 can be stored and received as utterance data 412 by the media delivery system 104. The utterance data 412 is data describing the utterance of the user query 120. In at least some embodiments, the utterance data 412 is an audio recording that contains the utterance being spoken. In some examples, the utterance data 412 is received as an entire audio data file. For instance, the media playback device 102 buffers the utterance data 412 as it is obtained from the sound detection device 162. The utterance data 412 that is buffered is then sent to the media delivery system 104 for processing. In other instances, the media playback device 102 streams the utterance data 412 to the media delivery system 104 in real-time as the utterance data 412 is received from the sound detection device 162 of the media playback device 102. In some examples, the utterance data 412 is stored (e.g., by the media delivery system 104) in a data store after it is received. After the utterance data 412 is received, the method 400 moves to operation 420.

Operation 420 includes performing automated speech recognition on the utterance data 412 to obtain text data 422. In some embodiments, performing automated speech recognition includes providing the utterance data 412 as input to an automated speech recognition system (e.g., the voice recognition application 270 of the voice interaction server 204) and receiving the text data 422 as output from the automated speech recognition system. Automated speech recognition can be performed using any of a variety of techniques (e.g., using hidden Markov models or neural networks). Examples of automated speech recognition systems include CMU SPHINX, maintained by CARNEGIE MELLON UNIVERSITY, and DEEPSPEECH, maintained by the MOZILLA FOUNDATION. After the text data 422 is obtained from the automated speech recognition system, the method 400 can move to operation 430.

Operation 430 includes determining a slot 434 and an intent 432 from the text data 422. The slot 434 is a key-value pair that describes a portion of the text data 422 having a specific meaning. The intent 432 describes a general intent of the text data 422. In the illustrated example of FIG. 1, if the text data 422 represents “play relaxing jazz for tonight” as input, the intent 432 is “play” and the slot 434 can include at least one key-value pair, such as {descriptor:relaxing} and {descriptor:tonight}. In another example, if the text data 422 includes “play Thriller” as input, the intent 432 is “play” and the slot 434 is a key-value pair of {song: Thriller}.

In some embodiments, the text data 422 can include a single slot 434 and a single intent 432. In other embodiments, the operation 430 can return a plurality of slots 434 and/or a plurality of intents 432 from the text data 422. In yet other embodiments, the text data 422 provides an intent 432 but no slot 434. For example, where the text data 422 is “play,” the operation 430 can return the intent 432 being “play”, but will not result in any slot 434 (e.g., the text data 422 does not include a description of what to play). In other examples, the text data 422 can include one or more slots 434 but no intent. For instance, where the text data 422 is “All Along the Watchtower by Jimi Hendrix,” the operation 430 can result in two slots 434 (e.g., {Song: All Along the Watchtower} and {Artist: Jimi Hendrix}) but no intent 432 (e.g., the text data 422 does not include a description of what do to with the song and artist, such as search, play, or save).

As described herein, the text data 422 can include one or more descriptors. In some embodiments, the descriptors can include values of one or more of the slots 434 identified from the text data 422. In the illustrated example of FIG. 1, where the text data 422 includes “play relaxing jazz for tonight” converted from the utterance of the user query 120, the values of the slots 434, such as “relaxing,” “relaxing jazz,” and/or “tonight,” can be included as descriptors of the text data 422. In other embodiments, the descriptors of the text data 422 can include the value of the intent 432 (e.g., “play” in the above example). In yet other embodiments, other terms identified in the text data 422 (e.g., “jazz”) can be included in the descriptors of the text data 422. In yet other embodiments, the descriptors of the text data 422 can be identified in other methods.

In some embodiments, the operation 430 can be performed by a natural language understanding model that is trained to identify the slot 434 and intent 432 for the text data 422 provided as input. The natural language understanding model can be implemented in a variety of ways, including using a state vector machine or a conditional random fields model, among others. With the intent 432 and the slots 434 determined, the method 400 can move to operation 440.

Operation 440 includes determining a fulfillment strategy 442 using the slot 434 and the intent 432. The fulfillment strategy 442 is a course of action to be performed to execute a command or service associated with the utterance, such as the intent 432 thereof. As described herein, the fulfillment strategy 442 can include a descriptive search service in response to the user query 120. In another example, where the intent 432 is a play intent, the fulfillment strategy 442 is a play fulfillment strategy and involves execution of a play command.

In some embodiments, the media delivery system 104 includes a fulfillment manager that operates to select a fulfillment strategy 442 among a plurality of fulfillment strategies, which satisfies the received utterance. The plurality of fulfillment strategies can include a play fulfillment strategy, a basic search strategy (e.g., using entity-focused search), a descriptive search strategy, a recommendation strategy, and an unspecified search strategy. In some examples, the fulfillment manager follows a decision tree based the intent 432 and the slot 434. In other examples, each fulfillment strategy 442 defines requirements (e.g., a play fulfillment strategy may require a play intent) and the fulfillment manager selects a fulfillment strategy among the plurality of fulfillment strategies based on whether the associated requirement is met.

Once the fulfillment strategy 442 is selected, the fulfillment strategy 442 is then performed by the media delivery system 104. For example, where the fulfillment strategy 442 is determined to be a descriptive search service based on the intent 432 and/or the slot 434 of the text data 422, the media delivery system 104 performs descriptive media content search based on the text data 422 (e.g., at least one of the descriptors identified from the text data 422).

### Performing Descriptive Search for a Playlist Based on the User Query

FIG. 5 is a flowchart of an example method 500 for performing descriptive search for a playlist based on the user query 120. In some embodiments, the method 500 can be used to at least partially perform the operation 304 of the method 300 as illustrated in FIG. 3.

At operation 502, the media delivery system 104 can operate to identify descriptive terms associated with playlists. As described herein (e.g., in relation to FIG. 7), the playlists can include a subset of playlists from a playlist database, such as only curated playlists. The playlists are searched in response to the user query 120.

In some embodiments, the operation 502 is performed to set up a descriptive search database that is to be used to conduct a descriptive search. In some embodiments, the operation 502 can be performed to build and store the descriptive search database prior to receiving the user query 120. In other embodiments, the operation 502 is performed upon receiving the user query 120. An example of the operation 502 is illustrated and described in more detail herein, for example with reference to FIG. 6.

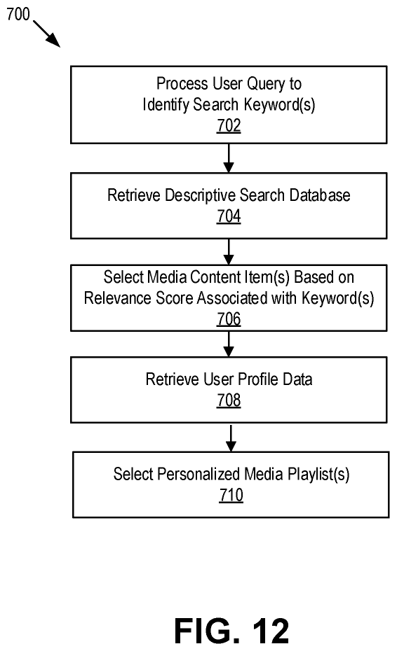

At operation 504, the media delivery system 104 can operate to select one or more playlists. In some embodiments, the operation 504 is performed to use the descriptive search database and conduct a descriptive search based on one or more descriptors of the user query 120. An example of the operation 504 is illustrated and described in more detail herein, for example with reference to FIG. 12.

### Improving Algorithmic Discoverability of Playlists

FIG. 6, which is made up of FIGS. 6A, 6B, 6C, and 6D, is a flowchart of an example process 1000 for improving algorithmic discoverability of playlists.

In the illustrated example, the process 1000 includes and begins with operation 1010. Operation 1010 includes selecting 1010 one or more candidate playlists. These selected candidate playlists 1012 are playlists selected to be used for labeling curated playlists 1062. The one or more selected candidate playlists 1012 each have a playlist description and a first plurality of tracks. In an example, the media delivery system 104 operates to retrieve the one or more selected candidate playlists 1012 from the candidate playlists 558 stored in the candidate playlist database described in FIG. 7. In many examples, the selecting includes selecting all of the candidate playlists 558. In some examples, selecting fewer than all of the candidate playlists 558 is desirable. For instance, there may be a large number of candidate playlists 558 and the processing described herein may be performed on batches of less than all of the playlists for efficiency or other reasons. Following operation 1010, the flow of the method moves to operation 1020.

Operation 1020 includes performing operation 1030 and operation 1040 for each respective candidate playlist 1022 of the selected candidate playlists 1012.

Operation 1030 includes tokenizing 1030 the playlist description 570 of the respective candidate playlist 1022 into one or more tokenized terms 1032. Tokenizing 1030 includes taking a playlist description 570 and generating tokenized terms 1032 therefrom. Tokenizing can be performed by natural language processing toolkits, such as the NLTK toolkit for PYTHON maintained by the NLTK PROJECT. The tokenized terms 1032 are the set of terms formed by the tokenizing. In examples, the tokenized terms 1032 can be referred to as “descriptive terms” because the resulting tokenized terms 1032 are descriptive of both the respective playlist from which the terms were generated as well as the tracks contained therein. The tokenizing 1030 can take various forms and can include splitting the playlist description 570 into individual words or phrases and using the individual words as the tokenized terms 1032. An example of the operation 1030 is illustrated and described in more detail herein, for example with reference to FIG. 8. The tokenizing 1030 can optionally include applying a filter, such as described in operation 1034.

Operation 1034 includes applying one or more filters before, after, or while generating the tokenized terms 1032. Filtering before the tokenizing can include removing or modifying words in the playlist description 570. Filtering while tokenizing can include incorporating the filters into tokenizing process, such as by not tokenizing words or phrases in an exclusion list. Filtering after tokenizing can include removing or modifying one or more tokens from the tokenized terms 1032.

In some examples applying the filter includes applying a lexicon 560 such that the tokenized terms 1032 include only those terms allowed by the lexicon 560. In some examples, the lexicon 560 can be referred to as a “gazetteer”. The lexicon 560 includes a list of words or phrases that is prepopulated and used as a vocabulary to identify descriptive terms from playlist descriptions 570 in the selected candidate playlists 1012. For example, the media delivery system 104 operates to retrieve a lexicon 560 (see, e.g., FIG. 8). Then each word of the playlist description 570 of the respective candidate playlist 1022 can be compared to the lexicon 560. If the respective word is contained in the lexicon 560, then the respective word is included as one of the tokenized terms 1032 for the respective playlist of the selected candidate playlists 1012.

The lexicon 560 can be used to clarify unclear terms in the playlist descriptions of the candidate playlists 558 and identify them as descriptive terms relevant to the descriptive search. In some embodiments, the lexicon 560 can be manually created and updated. The lexicon 560 can be at least partially automatically created and updated using, for example, machine learning technology. In an example, the lexicon 560 is at least partially automatically maintained based on descriptive terms received from user queries 120. For example, if more than a threshold number of users request playback of tracks or playlists using a description not present in the lexicon 560, then the system can automatically (or at least partially with the assistance of a human curator) add the description to the lexicon 560.

In some examples, the filtering includes applying a privacy filter 1038. The privacy filter 1038 is a filter configured to remove personally-identifiable information such that personally-identifiable information is not added to or does not remain in the tokenized terms 1032. In some examples, the privacy filter 1038 is configured to identify and omit personal information. For instance, the privacy filter 1038 can be or include a regular expression pattern matching filter configured to identify and remove patterns of identifiable information (e.g., a regular expression that matches phone numbers, email addresses, or street addresses). In an example, the privacy filter 1038 is a machine learning algorithm (e.g., a neural network) trained to identify personal information.

In some examples, the lexicon 560 can be used as the privacy filter 1038. For example, the use of the lexicon 560 as a white list for creating the tokenized terms 1032 can protect user privacy. For instance, a playlist description 570 may include information personal to the author of the playlist. But applying the lexicon 560 that does not include personally-identifiable information (an exception can be, e.g., personally-identifiable information associated with tracks or playlists themselves, such as artist names) to playlist description 570 can be used to filter out such personal information by not including personal information to begin with. Following operation 1030, the flow of the process 1000 can move to operation 1040.

Operation 1040 includes performing operation 1050 for each respective track 1042 in the respective candidate playlist 1022.

Operation 1050 includes tagging the respective track 1042 with the tokenized terms 1032. In examples, the tagging includes for each respective term of the one or more tokenized terms 1032, tagging the respective track 1042 with the respective term. In some examples, the tagging is responsive to the respective term passing a filter, such as one or more of the filters described above in operation 1034. Generally, the tagging includes establishing a relationship between each of the tokenized terms 1032 and the respective track 1042. The relationship can be unidirectional (e.g., from the respective track 1042 to each of the tokenized terms 1032 or vice versa) or bidirectional. In some examples, the tagging includes tagging the respective track in a track-term database 580, such as is described in operation 1052 and operation 1056.

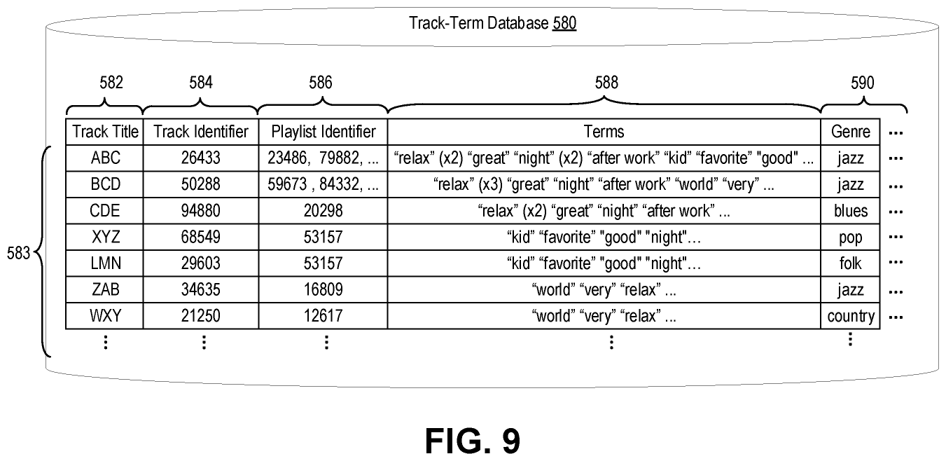

Operation 1052 includes identifying a respective track-term entry 1054 in a track-term database 580 that corresponds to the respective track 1042. This operation 1052 can include obtaining an identifier of the respective track 1042 and searching through the track-term database 580 for an entry of the track-term database 580 corresponding to the track identifier. If the search returns no result (e.g., an entry corresponding to the identifier is not found), then various actions can be taken. For example, an entry can be created for the respective track 1042. Alternatively, one or more related tracks can be identified and the identifiers of those related tracks can be used as the identifier of the respective track 1042 and the search is run again. Such related tracks may be, for example, tracks having a similar name by a same artist (e.g., as may be the result of live and studio versions of the same track). The track-term database 580 is described in more detail in FIG. 9. Following operation 1052, the flow of the process 1000 can move to operation 1056.

Operation 1056 includes ensuring that the respective track-term entry 1054 includes an association to the tokenized terms 1032. Ensuring that the respective track-term entry 1054 includes the association to the tokenized terms 1032 can take various forms. For example, it can include determining whether the track-term entry 1054 already includes the tokenized terms 1032. If the track-term entry 1054 does not include the tokenized terms 1032, then the tokenized terms 1032 can be added. If one or more of the tokenized terms 1032 already exist, then a counter associated with the one or more tokenized terms 1032 can be incremented. Alternatively, duplicate tokenized terms 1032 can be ignored.

Following operation 1056, the flow of the process 1000 can move to operation 1060, which is illustrated on FIG. 6B.

Operation 1060 includes performing for each respective curated playlist 1064: operation 1070 and one or both of: operation 1100 and operation 1200.

Operation 1070 includes selecting a subset 1072 of tracks from the tracks 1066 of the respective curated playlist 1064. In an example, the total count of the tracks 1066 of the respective curated playlist 1064 is the integer N. In some examples, the subset 1072 is all N tracks 1066 (i.e., the subset 1072 is not a proper subset of the tracks 1066). In many examples, the total count of the tracks in the subset 1072 is the integer M, where M<N (i.e., the subset 1072 is a proper subset of the tracks 1066).

In many playlists, the tracks 1066 are ordered. In such examples, the subset 1072 can be of the first M tracks in the order. Selecting the first M tracks can be advantageous because the first few tracks of a playlist are often the most representative of the theme of the playlist (e.g., the author of the playlist selects the most emblematic tracks first) to draw in listeners. As a result, having the subset 1072 encompass the first M tracks in the order where M<N can provide improved the algorithmic discoverability of the curated playlist 1064 by focusing the labeling of the curated playlist 1064 based on the most representative tracks without adding too many labels based on less representative tracks. In other examples, the first M tracks are the most popular (e.g., having the highest listen count) tracks in the playlist. In still other examples, the first M tracks are selected arbitrarily (e.g., at least pseudo-randomly).

Following operation 1070, the flow of the process 1000 can move to one or both of operation 1100 (which is described in detail in relation to FIG. 6C) and operation 1200 (which is described in detail in relation to FIG. 6D).

Turning to FIG. 6C, operation 1100 is illustrated. The operation 1100 includes making the curated playlist 1064 discoverable by a query application 250 via the one or more tokenized terms 1032. Generally, the curated playlist 1064 is associated with the tokenized terms 1032 in a data structure such that the query application 250 can identify the curated playlist by conducting a search of the data structure using one or more of the tokenized terms 1032 associated with the curated playlist 1064. For instance, where a user requests playback of “groovy” music, the query application 250 searches the data structure for curated playlists associated with the tokenized term “groovy”.

In examples, operation 1100 further includes operation 1110, which includes performing operations 1120 and 1130 for each respective track 1112 of the subset 1072 of the tracks 1066 of the respective curated playlist 1064.

Operation 1120 includes determining 1120 whether the respective track 1112 has been tagged with at least one tokenized term 1032. In examples, this operation 1120 includes using the track-term database 580. For instance, the track-term database 580 is searched for a track-term entry 583 corresponding to the respective track 1112 (e.g., by searching via an identifier of the respective track 1112). Then, the track-term entry 583 is analyzed to determine whether at least one tokenized term 1032 is stored in the term 588 field of the track-term entry 583. If not, the flow for this respective track 1112 ends. If there is at least one tokenized term 1032 stored in the term 588 field of the track-term entry 583, the at least one tokenized term 1032 is obtained from the track-term entry 583 and the flow of the process 1000 moves to operation 1130.

Operation 1130 includes storing, in the descriptive search database 610, an association between: (1) each of the at least one tokenized term 1032 with which the respective track 1112 has been tagged and (2) the curated playlist 1012. In many examples, this operation 1130 includes accessing and updating an existing descriptive search database 610. In other examples, the operation 1130 creates the descriptive search database 610. The descriptive search database 610 is a data structure storing one or more descriptive term entries 623 usable to find one or more playlists (e.g., curated playlists) based on a descriptive term. In some examples, the descriptive search database 610 takes the form of or includes an inverted index that maps the descriptive terms to playlists. For example, the descriptive search database 610 stores, in a descriptive term entry 623, a descriptive term that maps to the one or more playlists that are associated with that descriptive term. An example structure for the descriptive search database 610 is shown and described in relation to FIG. 10. Following operation 1100, the process 1000 can complete.

Turning to FIG. 6D, operation 1200 is illustrated. The operation 1200 includes updating the descriptive search database 610 based on corresponding track-term entries 1212. In examples operation 1200 includes operation 1210, which includes performing operation 1220 for each respective track-term entry 1214 of the corresponding track-term entries 1212. Operation 1220 includes performing operation 1230 and operation 1240 for each respective descriptive term 1224 of the one or more descriptive terms 1222 of the respective track-term entry 1214.

Operation 1230 includes selecting a corresponding descriptive term entry 1242 of the descriptive term entries 623 in the descriptive search database 610 that correspond to the respective descriptive term 1224. For example, the selecting can include performing a search of the descriptive search database 610 using the respective descriptive term 1224. If there is a descriptive term entry 623 found in the descriptive search database 610, then the found descriptive term entry 623 is selected as the corresponding descriptive term entry 1242. If there is not a descriptive term entry 623 found in the descriptive search database 610, then a descriptive term entry 623 is created that corresponds to the respective descriptive term 1224. The created descriptive term entry 623 is then selected as the corresponding descriptive term entry 1242. Following operation 1230, the flow of the process 1000 can move to operation 1240.

Operation 1240 includes ensuring that the respective curated playlist 1064 is associated with the corresponding descriptive term entry 1242. This can include adding an identifier and other data of the playlist in association with the corresponding descriptive term entry 1242. Following operation 1240, the process 1000 can complete.

### Playlist Databases, Candidate Playlist Selection Engine, and Curation Engine

FIG. 7 illustrates playlist databases, as well as a candidate playlist selection engine 550 for determining candidate playlists 558 and a curation engine 900 for curating playlists. The playlist databases include a playlist database 552 and a candidate playlist database 556.

The playlist database 552 is a data structure for storing playlists 554, and the candidate playlist database 556 is a data structure storing candidate playlists 558. The data structures of the playlist database 552 and the candidate playlist database 556 can take any of a variety of forms including a relational database, a non-relational database, or a portion of another data structure (e.g., a table within a relational database), among other data structures. In some examples, the candidate playlist database 556 is separate from the playlist database 552. In other examples, the candidate playlists 558 are stored as part of the playlist database 552 and are flagged or otherwise identified in the playlist database 552 or elsewhere as candidate playlists.

The data structures can store data regarding each of the playlists 554. An example playlist 554A is illustrated as including a playlist description 570 that includes a playlist title 574 and a descriptive text 576. As described herein, the playlist title 574 is a name of the playlist, which can be created either by the author of the playlist or by a media streaming service provider (e.g., by a person manually tagging the playlist or automatically naming the playlist based on common characteristics of the tracks contained therein). The descriptive text 576 can include words, phrases, or sentences that characterize the candidate playlist 558. The descriptive text 576 can also be obtained from various sources. In some examples, an author of the playlist 554A provides the descriptive text 576. In other examples, the descriptive text 576 is obtained from external sources, such as user or expert opinions or feedback (e.g., reviews or genre labels through websites, chatrooms, blogs, surveys, etc.), statistics (e.g., sales data), or any text information that may be used to describe, rank, or interpret the playlist or tracks associated with the playlist. In some embodiments, the descriptive text 576 can also be generated by a community of listeners and automatically retrieved from Internet sites, chat rooms, blogs, and the like. In some embodiments, the candidate playlist selection engine 550 is used to at least partially selecting one or more candidate playlists as described in operation 1010 of FIG. 6A.

The candidate playlist selection engine 550 operates to retrieve one or more of the playlists 554 stored in the playlist database 552 and flag, store, or otherwise identify them as one or more candidate playlists 558 in the candidate playlist database 556. In examples, the candidate playlist selection engine 550 identifies a subset of the playlists 554 from a playlist database 552. The identification of the subset of the playlists 554 can be performed by, for example, the candidate playlist selection engine 550 applying one or more filters 551 to the playlists 554 (e.g., the uncurated playlists 1014 thereof).

The one or more filters 551 can be configured to remove playlists that are unsuitable for use in improving the algorithmic discovery as described herein. For example, some of the playlists 554 in the playlist database 552 may have no or little playlist description, or playlist descriptions with no meaningful information with which to characterize a playlist. These playlists 554 in the playlist database 552 have less value in improving algorithmic discovery (e.g., by not contributing to the production of relevant search results in response to the user query 120). As another example, a filter for removing out homogeneous playlists may be beneficial. For instance, a playlist where the title is an artist or album name and the playlist includes only tracks by that artist or that album can be omitted because such a homogeneous playlist may provide little value in labeling the songs.

The candidate playlist selection engine 550 can use one or more filters 551. The filters 551 can be implemented in any of a variety of ways. In many examples, the filters 551 describe how the playlists 554 are to be analyzed. The candidate playlist selection engine 550 can implement the filters 551 as heuristic techniques or sets of predetermined rules for selecting playlists 554. In examples, the filters 551 include tests for the playlists 554. In examples the filters 551 are implemented in conjunction with: a natural language understanding system configured to analyze components of the playlist 554 (e.g., the playlist description 570), a machine learning algorithm (e.g., a neural network) trained to distinguish candidate playlists that meet certain criteria, a regular-expression-based pattern matching, or other techniques. In still other examples, one or more of the filters 551 can be manual filters performed by one or more people (e.g., a person can manually filter out a playlist 554). In examples, the filter 551 can be configured to filter-out playlists or filter-in playlists. In an example, the candidate playlist selection engine can flag a playlist 554 as a candidate playlist 558 responsive to the playlist 554 passing one or more of the filters 551. In another example, candidate playlist selection engine 550 processes each of the playlists 554 as a candidate playlist 558 by default and then flags respective playlists 554 as not candidates responsive to the playlist 554 not passing one or more of the filters 551. In examples, the one or more filters 551 include: a title filter; a descriptive text filter; a track filter, a curated playlist filter, and an author filter.

A title filter is a filter 551 configured to filter playlists 554 based on playlist titles 574 of the playlists 554. For example, the title filter can filter out playlists 554 having playlist titles 574 that are empty (e.g., contain no text), contain fewer than a threshold number of words in a selected language (e.g., the title contains unintelligible content, such as by determining whether the playlist title 574 has one or more words contained in a dictionary for a specific language), contains offensive language (e.g., the playlist title 574 contains one or more words contained in a list of prohibited words), or contains undesirable language (e.g., the playlist title 574 contains one or more words contained in a list of undesirable words, such as words that determined to be offensive, irrelevant, or generally unhelpful in improving algorithmic discovery). The title filter can serve other purposes as well.

The descriptive text filter is a filter configured to filter playlists 554 based on descriptive text 576 of the playlists 554. For example, the descriptive text filter can filter out playlists 554 having descriptive text 576 that is empty (e.g., contains no text), contains fewer than a threshold number of words in a selected language (e.g., the title contains unintelligible content, such as by determining whether the descriptive text 576 has one or more words contained in a dictionary for a specific language), contains offensive language (e.g., the descriptive text 576 contains one or more words contained in a list of prohibited words), or contains undesirable language (e.g., the descriptive text 576 contains one or more words contained in a list of undesirable words, such as words that determined to be unhelpful in the process). The descriptive text filter can serve other purposes as well.

The track filter is a filter 551 configured to filter playlists 554 based on the tracks 578 of the playlists 554. For example, the filter 551 can determine whether filter the playlist based on the playlist including a certain number of tracks (e.g., more than a threshold amount of tracks) or including certain types of tracks (e.g., tracks that are explicit, karaoke versions, cover versions, kid-friendly cover versions, instrumental versions, or have other desirable or undesirable characteristics based on track metadata or other sources of information).

The curated playlist filter is a filter 551 configured to filter playlists 554 based on whether the playlist 554 is a curated playlist 1062 or not. In some configurations, a playlist 554 passes the filter 551 if it is curated (e.g., flagged as curated in the playlist's metadata). In other configurations, the playlist does not pass the filter 551 if it is curated.

The author filter is a filter 551 configured to filter playlists 554 based on the author of the playlists. For instance, certain authors may manually or automatically be flagged as being authorized or unauthorized sources of candidate playlists 558. Playlist authors identified as being spammers or malicious actors can be flagged unauthorized so that playlists created by such authors are prevented from being identified as candidate playlists 558.

The candidate playlists 558 in the candidate playlist database 556 can be updated as the playlists 554 in the playlist database 552 change. For example, the playlists 554 can change in the playlist database 552 as users create new playlists, edit or remove existing playlists, and add, remove, and modify tracks in existing playlists. In some embodiments, the candidate playlists 558 can be updated periodically, in real-time, and/or at preset times.

The curation engine 900 facilitates the creation of curated playlists 1062. In an example, for a given playlist of the playlists 554, the curation engine 900 identifies the given playlist as a curated playlist responsive to the given playlist meeting one or more conditions (e.g., at least one conditions). The conditions can be determined based on metadata flags associated with the respective playlists. In examples, the conditions include: the playlist being authored by an author having escalated privileges, the playlist being selected by a curator (e.g., a human or algorithmic curator designated by a media streaming service), the playlist being flagged as a curated playlist, the playlist having more than a threshold number of listeners, or the playlist having more than a threshold number of followers. Responsive to identifying the playlist as a curated playlist, the curation engine 900 adds the given playlist to the curated playlists 1062, such as by flagging the given playlist as a curated playlist.

### Producing Tokenized Terms from a Playlist Description

FIG. 8 illustrates producing tokenized terms 1032 from a playlist description 570, such as described in operation 1030 of FIG. 6A.

For each selected candidate playlist 1012, the playlist description 570 of the respective candidate playlist 1022 can be tokenized into tokenized terms 1032. For example, for a respective candidate playlist 1022, its playlist description 570 is analyzed such that one or more keywords in the playlist description 570 are identified and stored as one or more tokenized terms 1032. In some embodiments (e.g., as described in relation to operation 1034 of FIG. 6), the lexicon 560 is used in the tokenization.

In the illustrated example, a first selected candidate playlist 1012A contains a playlist description 570 including the string “Relaxing Night” as the playlist title 574 and the string “Great for relaxation after work” as the descriptive text 576. The media delivery system 104 can tokenize the text of the playlist description 570 to identify keywords, such as “relaxing”, “night”, “great”, “relaxation”, and “after work” and generate tokens for such keywords or their variants for inclusion in the tokenized terms 1032A. Second and third candidate playlists 558B and 558C are similarly analyzed to generate the tokenized terms 1032B and 1032C, respectively.

The playlist description 570 can be tokenized in various ways. In some embodiments, the playlist description 570 can be tokenized by a single word. In other embodiments, the playlist description 570 can be tokenized by a combination of adjacent words if such adjacent words are determined to be related. Other methods are also possible.

### Track-Term Database

FIG. 9 illustrates an example track-term database 580 having track-term entries 583 that associate one or more tracks 234 (as identified by a track title or track identifier) with one or more terms 588. In an example, the track-term database 580 stores track-term entries 583, where each of the track-term entries 583 associates a track (e.g., via a track title 582 or a track identifier 584) with one or more terms 588. In some embodiments, the track-term entries 583 are added or updated in the manner described in operations 1050, 1052, and 1056 as described in FIG. 6. In some examples, the track-term database 580 is separate from a database storing general track information. In other examples, the relevant track-term information is a part of a general track information database, thereby making the general track information database the track-term database 580.

In some embodiments, the track-term database 580 is configured as a data table with track-term entries 583 storing data corresponding to: a track title 582 column, a track identifier 584 column, a playlist identifier 586 column, a terms 588 column, and one or more metadata columns 590. The track title 582 column shows the titles of the tracks 234. The track identifier 584 column shows the identifier (e.g., a uniform resource identifier (URI)) of the tracks 234. The playlist identifier 586 column shows the identifiers of the playlists that contain respective tracks 234. The descriptive term 588 column shows the terms 588 associated with respective tracks 234. As described herein, the terms 588 for a given track 234 can be identified from the playlists (e.g., the candidate playlists 558) containing that track 234.

As illustrated, each of the tracks 234 from the candidate playlists 558 are associated with the terms 588 identified from the candidate playlists 558 by being in a same track-term entry 583. By way of example, the track-term entry 583 corresponding to track 234 titled “ABC” is identified as having the track identifier “26433” and is associated with the descriptive terms, “relax” or its variants (e.g., “relaxing” or “relaxation”), “great,” “night” or its variants (e.g., “tonight”), “after work,” “kid,” “favorite,” and “good,” which are identified from the candidate playlists 558A, 558B, and 558C. This track 234 is associated with the descriptive term “relax” or its variants twice from the candidate playlists 558A, 558B, and 558C, and also associated with the descriptive term “night” or its variants twice from the selected candidate playlists 1012A, 1012B, and 1012C. Duplicate tokens can be handled in any of a variety of different ways. In examples, duplicate tokens are ignored. In some examples, duplicate terms are maintained (e.g., the term “relax” may appear twice in the terms 588 field for an entry 583). In other examples, duplicate terms are tracked by incrementing a count associated with the term. For example, a term can be stored as a key-value pair with the key being the term and the value being the frequency of occurrence of the term or its variants. For instance, the term “relax” having 3141 occurrences for track can be stored as the key-value pair {“relax”, 3141} in the terms 588 field of the entry 583.

The association of the terms 588 identified from the selected candidate playlists 1012 with the tracks 234 in the candidate playlists 558 provides additional descriptive information to the tracks 234. The tokens obtained from the playlist description 570 can be an indication of the characteristics of the tracks contained in that playlist. Therefore, a playlist description of a playlist can suggest the characteristics of the tracks in the playlist.

In some embodiments, the track-term database 580 also includes at least part of the information from metadata (e.g., the metadata 236) of the tracks 234. Such metadata information is shown in one or more of the metadata columns 590. In the illustrated example of FIG. 9, the metadata columns 590 includes a column for genre of the tracks 234.

### Descriptive Search Database

FIG. 10 illustrates an example of the descriptive search database 610. In some embodiments, the descriptive search database 610 is generated and/or updated at least partially by the operation 1130 as described in FIG. 6. In many examples herein, the descriptive search database 610 stores descriptive term entries 623 with each of the descriptive term entries 623 associating a descriptive term 622 with at least one curated playlist 1062 of the plurality of curated playlists 1062 via a playlist identifier of the curated playlist 1062. In an example implementation, the descriptive search database 610 stores descriptive term entries 623, where each of the descriptive term entries 623 associates a descriptive term 622 with at least one curated playlist 1062 of the plurality of curated playlists 1062.

In some embodiments, the descriptive search database 610 includes an inverted index structure 620 that maps the terms 588 to the playlists 554. Other indexing methods are also possible in the descriptive search database 610.

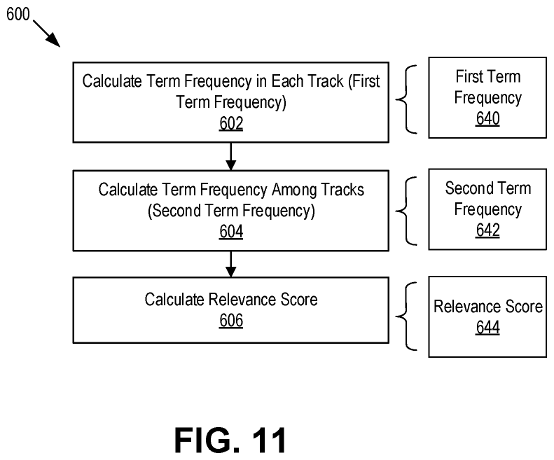

In some embodiments, the inverted index structure 620 is configured as a data table having a descriptive term 622 column, an playlist identifier column 626, a relevance score column 628, and one or more metadata columns 630. The descriptive term 622 column stores descriptive terms, such as the tokens identified from the candidate playlists 558. The playlist identifier column 626 shows the identifier (e.g., a uniform resource identifier (URI)) of one or more playlists. The relevance score column 628 includes relevance scores calculated for each token with respect to each track 234. In some embodiments, the relevance scores can be obtained by the method 600 as described in FIG. 11. The metadata columns 630 includes at least part of the information from metadata (e.g., the metadata 236) of the playlists 554. As described herein, the metadata of the playlists 554 can be additionally used to improve the search results.

### Weighting Relevance of a Descriptive Term

FIG. 11 is a flowchart of an example method 600 for generating a relevance score, such as a relevance score weighting the relevance of a descriptive term for a playlists. In some embodiments, the method 600 is used to at least partially calculate the relevance scores 628 of descriptive term entries 623 in the descriptive search database 610. In some embodiments, the method 600 can be used to compute how relevant a given playlist 554 is to the user query 120. The method 600 can provide a solution to ranking the playlists 554 in view of the user query 120. In some embodiments, the method 600 can determine how relevant or important a given descriptive term is to a given playlist among a plurality of playlists 554.

The method 600 can begin at operation 602 in which the media delivery system 104 operates to calculate a first term frequency 640. The first term frequency 640 is a term frequency in each of the playlists 554. The first term frequency 640 is a measure of how frequently a particular term (e.g., a descriptive term) appears in a document (e.g., a playlist description 570 of a specific playlist). In some embodiments, the first term frequency (TF) 640 can be computed as:

$$TF ( descriptive term , playlist ) = \frac{ \begin{matrix}Number of times the descrptive \\ term appears in the playlist description\end{matrix}}{ \begin{matrix}Total number of descriptive \\ terms in the playlist description\end{matrix}}$$

At operation 604, the media delivery system 104 operates to calculate a second term frequency 642. The second term frequency 642 is a measure of how frequently a particular term (e.g., a descriptive term) appears in all documents (e.g., all playlists' descriptions). In some embodiments, the second term frequency (IDF) 642 can be computed as:

$$IDF ( descriptive term ) = ln ( \frac{Total number of playlists}{Number of playlists having descriptions containing the term} )$$

It is noted that IDF=0 if the term does not appear in any playlist descriptions.

At operation 606, the media delivery system 104 operates to calculate a relevance score 644 based on the first term frequency 640 and the second term frequency 642. The relevance score 644 is a measure of how relevant a particular term (e.g., a descriptive term) is to a document (e.g., a playlist 554). In some embodiments, the relevance score 644 can be computed as:

Relevance Score(descpritive term, playlist)=TF(descriptive term, playlist)×IDF(descriptive term)

In some embodiments, the method 600 implements a term frequency and inverse document frequency (TFIDF) weighting. In other embodiments, other weighting algorithms can be used for the method 600.

### Performing a Descriptive Search with a Descriptive Search Database

FIG. 12 is a flowchart of an example method 700 for performing a descriptive search with the descriptive search database 610. In some embodiments, the method 700 is used to at least partially perform the operation 504 as illustrated in FIG. 5 to select a playlist.

In some embodiments, the method 700 is used to select one or more playlists of the playlists 554 in the playlist database 552 (e.g., one or more of the curated playlists 1062) by using the descriptive search database 610 and conducting a descriptive search based on one or more descriptors of the user query 120. In an example, the method 700 includes receiving a user query 120 that includes at least one descriptor 736. Then an association is found in the descriptive search database 610 that has the least one of the descriptors 736, determining that the association is with a curated playlist 1062, and then initiating playback of the curated playlist responsive to the determining. In examples, the finding of the association in the descriptive search database 610 includes determining whether a relevance score 644 of the association passes a predetermined threshold.

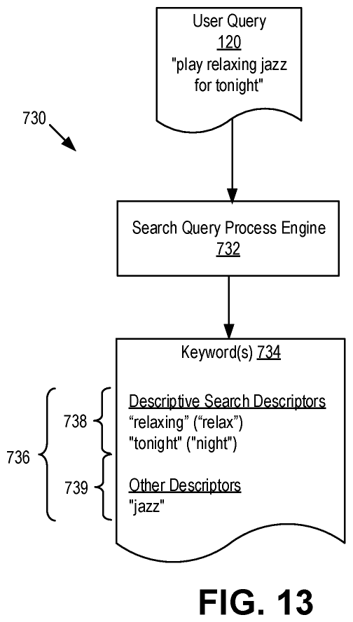

The method 700 can begin at operation 702 in which the media delivery system 104 operates to process the user query 120 to identify one or more search keywords 734 for use an identifying a playlist that satisfies the user query 120. In some embodiments, the user query 120 is analyzed to identify one or more descriptors 736, and one or more of the descriptors 736 from the user query 120 can be used for one or more search keywords 734. An example of the operation 702 is illustrated and described in more detail herein, for example with reference to FIG. 13.

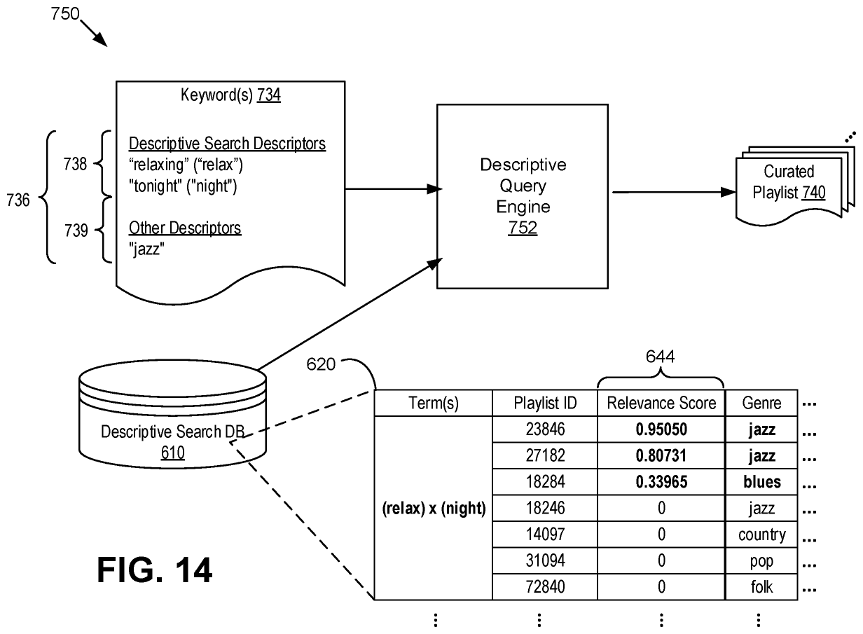

At operation 704, the media delivery system 104 retrieves the descriptive search database 610. At operation 706, the media delivery system 104 operates to select one or more playlists 740 based on the relevance score 644 associated with the search keywords 734. An example of the operations 704 and 706 is illustrated and described in more detail herein, for example with reference to FIG. 14.

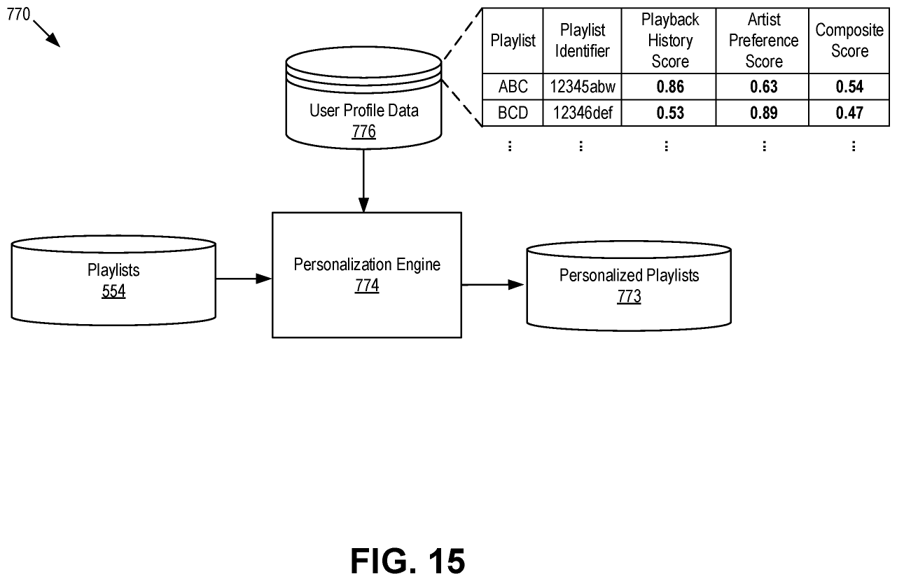

At operation 708, the media delivery system 104 retrieves user profile data 776 (See, e.g., FIG. 15). At operation 710, the media delivery system 104 operates to select one or more personalized playlists 772 based on the user profile data 776. An example of the operations 708 and 710 is illustrated and described in more detail herein, for example with reference to FIG. 15. In an example, the one or more personalized playlists 772 are provided to the media playback device 102 for presentation to a user. In other examples, playback of one of the one or more personalized playlists 772 is initiated (e.g., by causing playback of a first track of the playlist at the media playback device 102).

In some embodiments, at least one of the operations 702, 704, 706, 708, and 710 is performed prior to the operation 502 as illustrated in FIG. 5 while the rest of the operations 702, 704, 706, 708, and 710 follows the operation 502. In other embodiments, the operations 702, 704, 706, 708, and 710 are performed after the operation 502 as illustrated in FIG. 5.

### Analyzing the User Query to Identify One or More Keywords

FIG. 13 illustrates an example method 730 for analyzing the user query 120 to identify one or more keywords 734. In some embodiments, the method 730 is used to at least partially perform the operation 702 as described in FIG. 12. As described herein, the user query 120 is a text query that is typed by the user, or a voice request (e.g., an utterance) received through a microphone and converted into a text query.

In some embodiments, the method 730 can be performed at least by a user query process engine 732 that can be included in the media delivery system 104. The user query process engine 732 can operate to analyze the user query 120 and generate the keywords 734. In some embodiments, the user query 120 is tokenized into tokenized terms (e.g., words or phrases), which include descriptors 736. At least one of the descriptors 736 can be used as the search keywords 734.

By way of example, the user query 120 is a search request “play relaxing jazz for tonight”. The user query process engine 732 operates to process the user query 120 and identify the search keywords 734, such as “relaxing” (or its variants), “tonight” (or its variants), “jazz” (or its variants), etc.

In some embodiments, the search keywords 734 include at least one of the descriptors 736 from the user query 120, such as descriptive search descriptors 738 and other descriptors 739. In some embodiments, the descriptive search descriptors 738 are primarily used to perform a descriptive search as described herein. The other descriptors 739 can be used to perform other types of search, such as entity-focused search using media content metadata. As described herein, the other descriptors 739 can be used in addition to the descriptive search descriptors 738 to improve the search results from the descriptive search responsive to the user query 120.

In some embodiments, the user query process engine 732 refers to the descriptive search database 610 to identify the search keywords 734 by checking to see if any of the tokenized terms (or the descriptors) in the user query 120 match any of the descriptive terms in the descriptive search database 610. If so, such tokenized terms from the user query 120 are identified as search keywords to be used in the descriptive search.

### Selecting Curated Playlists Using the Descriptive Search Database

FIG. 14 illustrates an example method 750 for selecting curated playlists 740 based on descriptive search using the descriptive search database 610. In some embodiments, the method 750 is used to at least partially perform the operations 704 and 706 as described in FIG. 12.

In some embodiments, the method 750 can be performed at least by a descriptive query engine 110 that can be included in the media delivery system 104. The descriptive query engine 110 can process the search keywords 734 based on the descriptive search database 610 and return one or more curated playlists 740 that match the user query 120.

In some embodiments, the descriptive query engine 110 selects the curated playlists 740 based on the relevance score 644. In an example, the relevance score 644 is calculated using the process described in FIG. 11. In addition or instead, the relevance score 644 is calculated based on how frequently a respective playlist is tagged with the terms being searched (e.g., the relevance score is a count of the frequency of the terms). For instance, a playlist being tagged with twice as many instances of the term “relaxing” as another playlist can have double the relevance score. The curated playlists 740 can be selected to match the search keywords 734 and have the highest relevance scores 644. In some embodiments, a predetermined number of curated playlists 740 are selected having the highest relevance scores 644 (e.g., top ten curated playlists). In other embodiments, the number of curated playlists 740 are determined based on other factors, such as a relevance score threshold.

In other embodiments, the descriptive query engine 110 can employ other algorithms to select the curated playlists 740 in response to the user query 120. For example, the descriptive query engine 110 can operate to obtain a relevance score vector for each of the candidate playlists 558. Further, the descriptive query engine 110 can operate to obtain a corresponding vector for the user query 120. Then, the descriptive query engine 110 operates to compare each of the relevance score vectors for the tracks 234 with the corresponding vector for the user query 120, and determine similarity based on the comparison. In some embodiments, cosine similarity can be used to determine the similarity between the vectors. The descriptive query engine 110 can select curated playlists 740 having relevance score vectors with the highest similarities with the corresponding vector for the user query 120. Other algorithms are also possible in other embodiments.

In some embodiments, where a plurality of keywords 734 are used for search, the relevance score 644 for a track containing the plurality of keywords 734 can be computed by multiplication of individual relevance scores 644 for each of the keywords 734 associated with the track. An example of this case is illustrated with the inverted index structure 620 in FIG. 14.

In some embodiments, the descriptive query engine 110 can use other information about the playlists 554, such as information from metadata (e.g., the metadata 236) of the tracks 234, to provide even more relevant search results. In the illustrated example of FIG. 14, genre information of the tracks 234 are used in view of the other descriptors 739 (e.g., “jazz”) in the search keywords 734. For example, in addition to the descriptive search described herein, the descriptive query engine 110 can further operate to search for playlists 554 having information from the metadata that matches the other descriptors 739 of the search keywords 734. As such, the metadata of playlists 554 can improve the search results from the descriptive search. By way of another example, where a user query includes a combination of descriptive search terms and other typical descriptors, such as “play some relaxing jazz music like Miles Davis songs”, in which case the typical music search algorithm (e.g., using track metadata) can be used to identify playlists “like music by Miles Davis”, and the descriptive search algorithm can be used to identify “relaxing” music by the same artist.

### Selecting Personalized Playlists from the Curated Playlists

FIG. 15 illustrates an example method 770 for selecting personalized playlists 772 from the curated playlists 740. In some embodiments, the method 770 is used to at least partially perform the operations 708 and 710 as described in FIG. 12.

In some embodiments, the method 770 can be performed at least by a personalization engine 774 that can be included in the media delivery system 104. The personalization engine 774 can select playlists that are personalized to the user based at least in part on user profile data 776. As such, the method 770 enables search results to be personalized based on the user profile data 776.

In some embodiments, the personalization engine 774 uses the user profile data 776 to select one or more playlists 554 (e.g., curated playlists 740) that are selected by the descriptive search as described herein. The personalization engine 774 then outputs one or more of the selected playlists as personalized playlists 772.

In some embodiments, the user profile data 776 include user information. The user information can include one or more user specific features that can be used to determine media content personalized to respective users. The user specific features can represent the user's preference, media content consumption history, and/or other general features associated with the user of the media playback device 102. A few examples of user specific features include various user media content consumption activities (e.g., listening activities), such as the most listened context (e.g., track, album, artist, playlist, etc.), the most preferred context (e.g., track, album, artist, playlist, etc.), and the most preferred genre or other acoustic feature. The user specific features can be obtained based on the user's long-term activities (e.g., over a few months, a year or longer, etc.) or short-term activities (e.g., over a year or less, a month, a week, etc.).

In some embodiments, the user information includes user biographical information and user taste profile information. The user biographical information include features relating to personal information of respective users, such as address, age, gender, birth date/year, family, relationships, profession, education, religious preference, sexual preference, association, and other information associated with users. In some embodiments, the user biographical information can be obtained at least partially from the user account information.

The user taste profile information include features that can be obtained from taste profiles 242 of respective users, which represent the user's activities with respect to media content consumption, such as user preferences and history of consuming media content, as described herein. As described herein, the user taste profile information includes a user listening history, and other user-related data that can be used to personalize the search results. In some embodiments, the user taste profile information can further include taste profiles of other users having similar tastes.

The user profile data 776 can provide scores of one or more user activities with respect to each of the curated playlists 740 (e.g., “ABC” and “BCD”). By way of example, the user profile data 776 for the particular user provides a playback history score for each playlist 740 to represent how often the user has played the playlist 740 or the tracks therein. The user profile data 776 can also provide an artist preference score to represent how much the user likes the artist of each of the curated playlists 740. In some embodiments, where a plurality of scores are considered, the user profile data 776 can provide a single score (“Composite Score”) that represents all the scores. In some embodiments, such a single score can be calculated by multiplication of the plurality of scores. Then, when processing the playlists 554, the personalization engine 774 can filter the playlists 554 based on the composite scores of the respective playlists 554. For example, only playlists passing a certain threshold become personalized playlists 773. In another example, the playlists 554 operated on by the personalization engine are search results from the query server 202. The personalization engine 744 can rank the results according to corresponding composite scores, thereby creating the personalized playlists 773. The ranked results can then be sent to the media playback device 102 for presentation to the user. In other examples, the media delivery system 104 can initiate playback of a highest-ranked playlist (e.g., by initiating playback of a first track thereof or a highest-ranked track thereof as determined by the user profile data 776)

Although the systems and the methods according to the present disclosure are primarily described to return curated playlists 740 or 772 as output, it is also possible that the systems and the methods are similarly configured to generate other types of media content, such as media contexts (e.g., playlists, albums, artists, etc.), as output.

As used herein, the term “engine” is applied to describe a specific structure for performing specific associated functions, such as a special purpose computer as programmed to perform algorithms (e.g., processes) disclosed herein. The engine can take any of a variety of structural forms, including: instructions executable to perform algorithms to achieve a desired result, one or more processors (e.g., virtual or physical processors) executing instructions to perform algorithms to achieve a desired result, or one or more devices operating to perform algorithms to achieve a desired result.

Where data structures are referred to, the data structure can be stored on dedicated or shared computer readable mediums, such as volatile memory, non-volatile, transitory, or non-transitory memory.

The various examples and teachings described above are provided by way of illustration only and should not be construed to limit the scope of the present disclosure. Those skilled in the art will readily recognize various modifications and changes that may be made without following the examples and applications illustrated and described herein, and without departing from the true spirit and scope of the present disclosure.

What is claimed is:

1. A method for improving algorithmic discoverability of curated playlists, the method comprising:
selecting a candidate playlist from a plurality of uncurated playlists, the candidate playlist having a playlist description and a first plurality of tracks;
tokenizing the playlist description of the candidate playlist into one or more tokenized terms;
tagging each respective track of the first plurality of tracks with the one or more tokenized terms;
selecting a respective curated playlist from a plurality of curated playlists, the curated playlist having a second plurality of tracks;
selecting a subset of tracks from the second plurality of tracks; and
making the curated playlist discoverable by a query application via the one or more tokenized terms, wherein making the curated playlist discoverable includes:
for each respective track of the subset of tracks:
determining whether the respective track has been tagged with at least one tokenized term; and
storing, in a descriptive search database, an association between:
each of the at least one tokenized term with which the respective track has been tagged; and
the curated playlist.

2. The method of claim 1,
wherein tagging each respective track of the first plurality of tracks includes:
identifying a respective track-term entry in a track-term database that corresponds to the respective track; and
ensuring that the respective track-term entry includes an association to the one or more tokenized terms; and
wherein determining whether the respective track has been tagged with the at least one tokenized term includes:
using the track-term database.

3. The method of claim 2, wherein the descriptive search database includes an inverted index.

4. The method of claim 1,
wherein the second plurality of tracks of the curated playlist has N tracks, where N is an integer; and
wherein selecting the subset of tracks from the second plurality of tracks includes:
selecting M tracks from the curated playlist, where M is an integer less than N.

5. The method of claim 4,
wherein the second plurality of tracks of the curated playlist has an order;
wherein the subset of M tracks are the first M tracks of the curated playlist in the order.

6. The method of claim 1, further comprising:
obtaining a third playlist;
identifying the third playlist as a curated playlist responsive to the third playlist meeting at least one of the following conditions:
the third playlist being authored by an author having escalated privileges;
the third playlist being selected by a curator;
the third playlist being flagged as a curated playlist;
the third playlist having more than a threshold number of listeners; and
the third playlist having more than a threshold number of followers; and
responsive to identifying the third playlist as a curated playlist, adding the third playlist to the plurality of curated playlists.

7. The method of claim 1, wherein tagging each respective track of the first plurality of tracks with the one or more tokenized terms includes:
for each respective term of the one or more tokenized terms, tagging the respective track with the respective term responsive to the respective term passing a privacy filter.

8. The method of claim 1, further comprising:
prior to tagging each respective track of the first plurality of tracks with the tokenized terms, filtering the tokenized terms to remove terms outside of a lexicon.

9. The method of claim 1, further comprising:
applying one or more filters to the plurality of uncurated playlists,
wherein the candidate playlist passes the one or more filters; and
wherein the one or more filters include at least one filter from the group:
a title filter configured to filter playlists based on playlist titles of the playlists;
a descriptive text filter configured to filter playlists based on descriptive text of the playlists; and
a track filter configured to filter playlists based on the tracks of the playlists.

10. The method of claim 1, wherein the playlist description includes: a playlist title and a descriptive text.

11. The method of claim 1, further comprising:
receiving a user query including at least one descriptor;
finding an association in the descriptive search database that has the at least one descriptor;
determining that the found association is with the curated playlist;
responsive to determining that the found association is with the curated playlist, initiating playback of the curated playlist.

12. The method of claim 11, wherein the finding the association in the descriptive search database includes determining whether a relevance score passes a threshold.

13. A system for improving algorithmic discoverability of curated playlists, the system comprising:
a playlist database storing a plurality of uncurated playlists and a plurality of curated playlists;
a track-term database storing track-term entries, each of the track-term entries associating a track with one or more descriptive terms;
a descriptive search database storing descriptive term entries, each of the descriptive term entries associating a descriptive term with at least one curated playlist of the plurality of curated playlists;
a descriptive query engine operative to return a playlist result in response to a user query, the playlist result being based on the descriptive search database and one or more descriptors in the user query;
one or more processors; and
a non-transitory computer-readable medium having instructions stored thereon that, when executed by the one or more processors, cause the one or more processors to:
select candidate playlists from the plurality of uncurated playlists;
for each respective candidate playlist of the candidate playlists:
tokenize a playlist description of the respective candidate playlist to form a set of tokenized terms; and
for each respective track in the respective candidate playlist:
identify a respective track-term entry of the track-term entries that corresponds to the respective track; and
ensure that the respective track-term entry includes an association to the set of tokenized terms; and
for each respective curated playlist of the plurality of curated playlists:
selecting a subset of tracks from tracks of the respective curated playlist; and
updating the descriptive search database based on corresponding track-term entries in the track-term database, the corresponding track-term entries corresponding to the subset of tracks.

14. The system of claim 13, wherein updating the descriptive search database based on corresponding track-term entries includes:
for each respective track-term entry of the corresponding track-term entries:
for each respective descriptive term of the one or more descriptive terms of the respective track-term entry:
selecting a corresponding descriptive term entry of the descriptive term entries that corresponds to the respective descriptive term; and
ensuring that the respective curated playlist is associated with the corresponding descriptive term entry.

15. The system of claim 13, wherein selecting the subset of tracks from tracks of the respective curated playlist includes:
selecting the first M tracks of the respective curated playlist, where M is an integer less than the total number of tracks in the respective curated playlist.

16. The system of claim 13, wherein tokenizing the playlist description of the respective candidate playlist to form the set of tokenized terms includes:
applying a lexicon such that the tokenized terms include only those terms allowed by the lexicon.

17. A method for improving algorithmic discoverability of curated playlists, the method comprising:
selecting candidate playlists from a plurality of uncurated playlists;
for each respective candidate playlist of the candidate playlists:
tokenizing a playlist description of the respective candidate playlist to form a set of tokenized terms; and
for each respective track in the respective candidate playlist:
identifying a respective track-term entry of track-term entries that corresponds to the respective track; and
ensuring that the respective track-term entry includes an association to the set of tokenized terms; and
for each respective curated playlist of the plurality of curated playlists:
selecting a subset of tracks from tracks of the respective curated playlist; and
updating the descriptive search database based on corresponding track-term entries in the track-term database, the corresponding track-term entries corresponding to the subset of tracks.

18. The method of claim 17, wherein updating the descriptive search database based on corresponding track-term entries includes:
for each respective track-term entry of the corresponding track-term entries:
for each respective descriptive term of the one or more descriptive terms of the respective track-term entry:
selecting a corresponding descriptive term entry of the descriptive term entries that corresponds to the respective descriptive term; and
ensuring that the respective curated playlist is associated with the corresponding descriptive term entry.

19. The method of claim 17, wherein selecting the subset of tracks from tracks of the respective curated playlist includes:
selecting the first M tracks of the respective curated playlist, where M is an integer less than the total number of tracks in the respective curated playlist.

20. The method of claim 17, wherein tokenizing the playlist description of the respective candidate playlist to form the set of tokenized terms includes:
applying a lexicon such that the tokenized terms include only those terms allowed by the lexicon.
